(19) United States
(12) Patent Application Publication
(10) Pub. No.: US 2016/0156575 A1
(43) Pub. Date: Jun. 2, 2016

(54) METHOD AND APPARATUS FOR PROVIDING CONTENT

(71) Applicant: Samsung Electronics Co., Ltd., Gyeonggi-do (KR)

(72) Inventors: Jin-Hong JEONG, Gyeonggi-do (KR); Ki-Huk LEE, Gyeonggi-do (KR); Kwang-Young KIM, Gyeonggi-do (KR); Kwang-Tai KIM, Gyeonggi-do (KR); Soo-Hyung KIM, Gyeonggi-do (KR); Hyun-Soo KIM, Gyeonggi-do (KR); Eun-Seok RYU, Seoul (KR); Yong-Man LEE, Gyeonggi-do (KR)

(21) Appl. No.: 14/952,177

(22) Filed: Nov. 25, 2015

(30) Foreign Application Priority Data
Nov. 27, 2014 (KR) 10-2014-0167568

(51) Int. Cl. H04L 12/58

(52) U.S. Cl. CPC H04L 51/063; H04L 51/20; H04L 51/10

(57) ABSTRACT

An electronic device comprising: a memory for storing a content item; and at least one processor operatively coupled to the memory, configured to: acquire a first information item corresponding to at least one of an external device or a user of the external device, generate narration information corresponding to the content item based at least in part on the first information item, and provide the content item and the narration information.

### CLAIM OF PRIORITY

This application claims priority under 35 U.S.C. §119(a) from an application filed in the Korean Intellectual Property Office on Nov. 27, 2014 and assigned Serial No. 10-2014-0167568, the contents of which are herein incorporated by reference.

### BACKGROUND

1. Field of the Disclosure

The present disclosure relates to electronic devices, in general, and more particularly to a method and apparatus for providing content.

2. Description of the Related Art

With the growth of electronic component technologies, electronic devices can perform various functions. Also, the electronic devices can acquire various contents and provide applications or services corresponding to the contents.

For example, the electronic device can perform drawing or acquire documents through users' touch input on touch screens. Or, the electronic devices can acquire images or videos through camera modules. Or, the electronic devices can acquire audios through audio input devices.

Or, the electronic devices can receive content through wireless communication. For instance, the electronic devices can acquire contents, based on at least one of various inputs acquired by the electronic devices or a combination thereof. Or, the electronic devices can provide the acquired contents to users or external devices.

### SUMMARY

According to aspects of the disclosure, an electronic device is provided comprising: a memory for storing a content item; and at least one processor operatively coupled to the memory, configured to: acquire a first information item corresponding to at least one of an external device or a user of the external device, generate narration information corresponding to the content item based at least in part on the first information item, and provide the content item and the narration information.

According to aspects of the disclosure, a method is provided comprising: storing a content item in a memory of an electronic device; acquiring, by the electronic device, a first information item corresponding to at least one of an external device or a user of the external device; generating, by the electronic device, narration information corresponding to the content item based at least in part on the first information item; and providing, by the electronic device, the content item and the narration information.

According to aspects of the disclosure, a non-transitory computer-readable medium is provided that stores one or more processor-executable instructions which when executed by at least one processor cause the at least one processor to perform a method comprising the steps of: storing a content item in a memory of an electronic device; acquiring a first information item corresponding to at least one of an external device or a user of the external device, generating narration information corresponding to the content item based at least in part on the first information item, and providing the content item and the narration information.

### BRIEF DESCRIPTION OF THE DRAWINGS

The above features, and advantages of the present disclosure will become more apparent from the following detailed description when taken in conjunction with the accompanying drawings in which:

FIG. 1 is a block diagram of an example of an electronic device, according to an embodiment of the present disclosure;

FIG. 2 is a diagram of an example of an electronic device, according to an embodiment of the present disclosure;

FIG. 3 is a diagram of an example of a program module, according to an embodiment of the present disclosure;

FIG. 4 is a diagram of an example of a network environment, according to an embodiment of the present disclosure;

FIG. 5 is a diagram of an example of a network environment, according to an embodiment of the present disclosure;

FIG. 6 is a diagram of an example of a narration module, according to an embodiment of the present disclosure;

FIG. 7 is a flowchart of an example of a process, according to an embodiment of the present disclosure;

FIG. 8 is a diagram of an example of a protocol stack, according to an embodiment of the present disclosure;

FIG. 9 is a flowchart of an example of a process, according to an embodiment of the present disclosure;

FIG. 10 is a sequence diagram of an example of a process, according to an embodiment of the present disclosure;

FIG. 11A is a sequence diagram of an example of a process, according to an embodiment of the present disclosure;

FIG. 11B is a sequence diagram of an example of a process, according to an embodiment of the present disclosure;

FIG. 12A is a sequence diagram of an example of a process, according to an embodiment of the present disclosure;

FIG. 12B is a sequence diagram of an example of a process, according to an embodiment of the present disclosure;

FIG. 13 is a sequence diagram of an example of a process, according to an embodiment of the present disclosure;

FIG. 14 is a flowchart of an example of a process, according to an embodiment of the present disclosure;

FIG. 15 is a flowchart of an example of a process, according to an embodiment of the present disclosure;

FIG. 16 is a diagram illustrating an example of the operation of the process of FIG. 15, according to an embodiment of the present disclosure;

FIG. 17 is a diagram illustrating an example of the operation of the process of FIG. 15, according to an embodiment of the present disclosure;

FIG. 18 is a diagram illustrating an example of the operation of the process of FIG. 15, according to an embodiment of the present disclosure; and

FIG. 19 is a diagram illustrating an example of the operation of the process of FIG. 15, according to an embodiment of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” at the hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or program module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device. For example, the electronic device according to various embodiments of the present disclosure may include at least one of: a smartphone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console(e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like).

In certain embodiments, an electronic device may include at least one of: a piece of furniture or a building/structure; an electronic board; an electronic signature receiving device; a projector; and various measuring instruments (e.g., a water meter, an electricity meter, a gas meter, or a wave meter).

An electronic device according to various embodiments of the present disclosure may also include a combination of one or more of the above-mentioned devices. Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

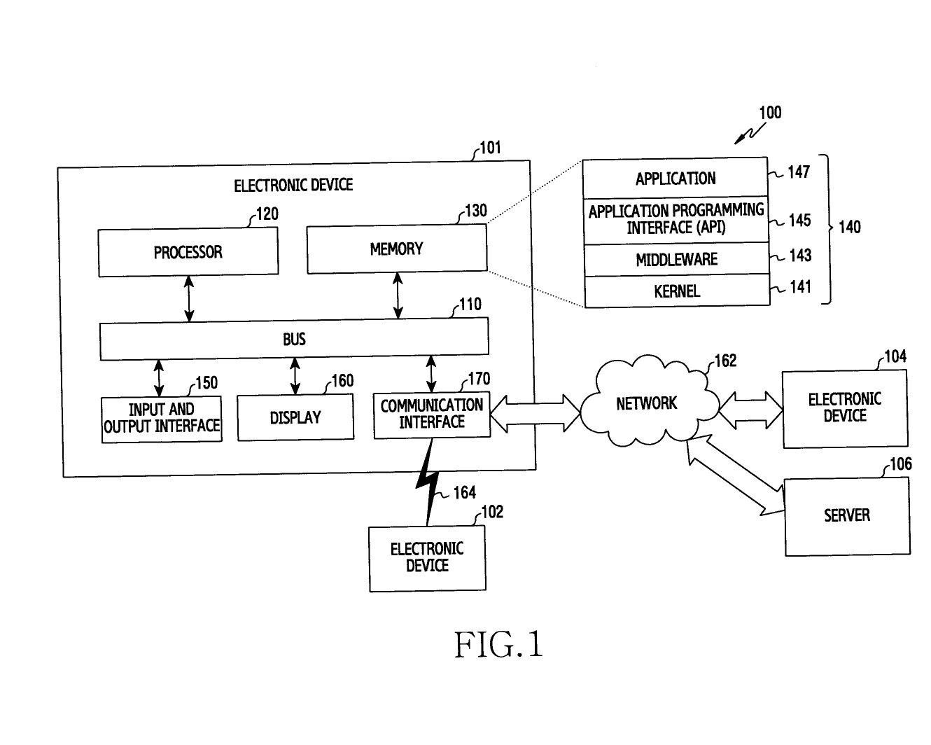

FIG. 1 is a block diagram of an example of an electronic device according to an embodiment of the present disclosure. Referring to FIG. 1, an electronic device 100 may include a bus 110, a processor 120, a memory 130, an input/output interface 150, a display 160, and a communication interface 170. According to various embodiments of the present disclosure, at least one of the components of the electronic device 100 may be omitted, or other components may be additionally included in the electronic device 100. The bus 110 may be a circuit that connects the processor 120, the memory 130, the input/output interface 150, the display 160, or the communication interface 170 and transmits communications (for example, control messages) between the above-described components.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. In operation, the processor 120 may construct a web page for displaying on the display 160 using a web page document stored in the memory 130 or provided by an external device (e.g., a first external electronic device 102, a second external electronic device 104, or a server 106) through the communication interface 170. For example, the processor 120 may parse the web page document (e.g., HTML document) to create a DOM tree for tags constructing the web page. The processor 120 may parse a style element of the web page to create a render tree. The processor 120 may control the display 160 to display the web page through rendering using the render tree.

According to one embodiment, if detecting an input for selection of at least a partial area of a web page through the input/output interface 150, the processor 120 may insert an attribute variable (e.g., a tag) for selecting and displaying, to a DOM tree for the area where the input is detected.

According to one embodiment, if detecting an input for selection of at least a partial area of a web page through the input/output interface 150, the processor 120 may control to update a render tree and display the area where the input is detected. To display the selection of a plurality of areas, the processor 120 may insert an attribute variable (e.g., a tag) for selecting and displaying, to a DOM tree for the area where the input is detected.

According to one embodiment, the processor 120 may store web page construction information (e.g., HTML information of an area where an input is detected) in a selection control module. For example, the processor 120 may store an attribute variable (e.g., a tag) for selecting and displaying and web page construction information in the selection control module. For instance, the selection control module may exist in at least one position of the internal or external of a web engine which consists of software constructing and driving a web page.

According to one embodiment, the processor 120 may extract web page construction information of at least one selected area, and construct a show page. For example, the processor 120 may search a DOM tree for an attribute variable for selecting and displaying, and identify at least one selected area. The processor 120 may extract the web page construction information of the at least one selected area, and create the show page. For example, the processor 120 may use the web page construction information of the at least one selected area stored in the selection control module, and create the show page. For instance, the show page may represent separate contents constructed to include at least a part of the web page construction information of the at least one area such that a user can identify the web page construction information of the at least one area selected by the user. The show page may include an electronic document including display data (e.g., image data, text data) included in at least one selected area, or a markup language document including HTML information (e.g., a tag, a script) included in the at least one selected area.

According to one embodiment, the processor 120 may reconstruct a web page to hide the displaying of at least one selected area on the web page displayed on the display 160.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may store, for example, instructions or data (e.g. image data) relevant to at least one other element of the electronic device 100. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 100 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 100, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided by the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 100. Furthermore, the input/output interface 150 may output the instructions or data received from the other element(s) of the electronic device 100 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160, for example, may display various types of content (e.g., text, images, videos, icons, or symbols). The display 160 may include a touch screen and receive, for example, a touch, gesture, proximity, or hovering input using an electronic pen or the user's body part. According to an embodiment, the display 160 may display a web page.

The communication interface 170, for example, may set communication between the electronic device 100 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short-range communication 164. The short-range communication 164 may include at least one of, for example, WiFi, Bluetooth, Near Field Communication (NFC), and Global Positioning System (GPS).

The wired communication may include at least one of, for example, a Universal Serial Bus (USB), a High Definition Multimedia Interface (HDMI), Recommended Standard-232 (RS-232), and a Plain Old Telephone Service (POTS).

The network 162 may include at least one of a communication network such as a computer network (e.g., a LAN or a WAN), the Internet, and a telephone network.

Each of the first and second external electronic devices 102 and 104 may be a device which is the same as or different from the electronic device 100. According to an embodiment, the server 106 may include a group of one or more servers. According to various embodiments, all or a part of operations performed in the electronic device 100 can be performed in the other electronic device or multiple electronic devices (for example, the external electronic device 102 or 104 or the server 106). According to an embodiment, when the electronic device 100 should perform some functions or services automatically or by a request, the electronic device 100 may make a request for performing at least some functions related to the functions or services to another device (for example, the external electronic device 102 or 104, or the server 106) instead of performing the functions or services by itself or additionally. Another electronic device (e.g., the external electronic device 102 or 104, or the server 106) may perform a function requested from the electronic device 100 or an additional function and transfer the performed result to the electronic device 100. The electronic device 100 can provide the requested function or service to another electronic device by processing the received result as it is or additionally. To this end, for example, cloud computing, distributed computing, or client-server computing technology may be used.

According to various embodiments of the present disclosure, the electronic device 100 may use at least one module operatively or physically separated from the processor 120 to construct a web page, and insert information about a selected area of the web page, and manage the information of the selected area.

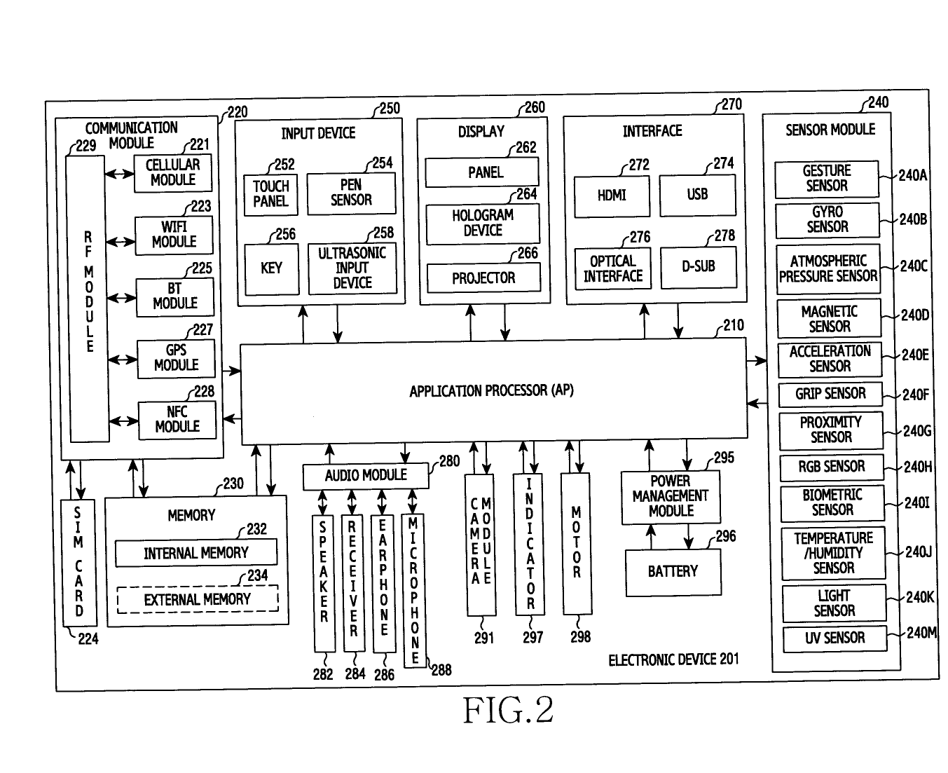

FIG. 2 is a diagram of an example of an electronic device, according to an embodiment of the present disclosure. In the following description, the electronic device may, for example, construct the whole or part of the electronic device 100 illustrated in FIG. 1.

Referring to FIG. 2, the electronic device may include one or more Application Processors (APs) 210, a communication module 220, a Subscriber Identification Module (SIM) card 224, a memory 230, a sensor module 240, an input device 250, a display 260, an interface 270, an audio module 280, an image sensor module 291, a power management module 295, a battery 296, an indicator 297, or a motor 298.

The AP 210 may run an operating system or an application program to control a plurality of hardware or software constituent elements connected to the AP 210, and may perform processing and operation of various data including multimedia data. The AP 210 may be, for example, implemented as a System-on-a-Chip (SoC). According to one embodiment, the AP 210 may further include a Graphic Processing Unit (GPU) (not shown).

The communication module 220 (e.g., the communication interface 160) may perform data transmission/reception in communication between the electronic device (e.g., the electronic device 101) and other electronic devices connected via a communications network. According to one embodiment, the communication module 220 may include a cellular module 221, a WiFi module 223, a BT module 225, a GPS module 227, an NFC module 228, and a Radio Frequency (RF) module 229.

The cellular module 221 may provide voice telephony, video telephony, a text service, or an Internet service, etc. through a telecommunication network (e.g., LTE, LTE-A, CDMA, WCDMA, UMTS, WiBro, or GSM, etc.). Also, the cellular module 221 may, for example, use a subscriber identification module (e.g., the SIM card 224) to perform electronic device distinction and authorization within the telecommunication network. According to one embodiment, the cellular module 221 may perform at least some of functions that the AP 210 may provide. For example, the cellular module 221 may perform at least one part of a multimedia control function.

According to one embodiment, the cellular module 221 may include a Communication Processor (CP). Also, the cellular module 221 may be, for example, implemented as a SoC. In FIG. 2, the constituent elements such as the cellular module 221 (e.g., the communication processor), the memory 230, or the power management module 295, etc. are illustrated as constituent elements different from the AP 210 but, according to one embodiment, the AP 210 may be implemented to include at least some (e.g., the cellular module 221) of the aforementioned constituent elements.

According to one embodiment, the AP 210 or the cellular module 221 (e.g., the communication processor) may load an instruction or data, which is received from a non-volatile memory connected to each or at least one of other constituent elements, to a volatile memory and process the loaded instruction or data. Also, the AP 210 or the cellular module 221 may store in the non-volatile memory data, which is received from at least one of the other constituent elements or is generated by at least one of the other constituent elements.

The WiFi module 223, the BT module 225, the GPS module 227 or the NFC module 228 each may include, for example, a processor for processing data transmitted/received through the corresponding module. In FIG. 2, the cellular module 221, the WiFi module 223, the BT module 225, the GPS module 227 or the NFC module 228 is each illustrated as a separate block but, according to one embodiment, at least some (e.g., two or more) of the cellular module 221, the WiFi module 223, the BT module 225, the GPS module 227 or the NFC module 228 may be included within one IC or IC package. For example, at least some (e.g., a communication processor corresponding to the cellular module 221 and a WiFi processor corresponding to the WiFi module 223) of the processors corresponding to the cellular module 221, the WiFi module 223, the BT module 225, the GPS module 227 or the NFC module 228 may be implemented as one SoC.

The RF module 229 may perform transmission/reception of data, for example, transmission/reception of an RF signal. Though not illustrated, the RF module 229 may include, for example, a transceiver, a Power Amplifier Module (PAM), a frequency filter, or a Low Noise Amplifier (LNA), etc. Also, the RF module 229 may further include a component for transmitting/receiving an electromagnetic waves, for example, a conductor or a conductive wire, etc. FIG. 2 illustrates that the cellular module 221, the WiFi module 223, the BT module 225, the GPS module 227 and the NFC module 228 share one RF module 229 with one another but, according to one embodiment, at least one of the cellular module 221, the WiFi module 223, the BT module 225, the GPS module 227 or the NFC module 228 may perform transmission/reception of an RF signal through a separate RF module.

According to one embodiment, the RF module 229 may include at least one antenna among a main antenna and a sub-antenna which are operatively connected to the electronic device. The communication module 220 may use the main antenna and the sub-antenna to support a Multiple Input Multiple Output (MIMO) such as diversity, etc.

The SIM card 224 may be a card including a subscriber identification module, and may be inserted into a slot provided in a specific position of the electronic device. The SIM card 224 may include unique identification information (e.g., an Integrated Circuit Card ID (ICCID)) or subscriber information (e.g., an International Mobile Subscriber Identity (IMSI)).

The memory 230 may include an internal memory 232 or an external memory 234. The internal memory 232 may include, for example, at least one of a volatile memory (for example, a Dynamic Random Access Memory (DRAM), a Static RAM (SRAM) and a Synchronous Dynamic RAM (SDRAM)) or a non-volatile memory (for example, a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, and a Not OR (NOR) flash memory).

According to one embodiment, the internal memory 232 may be a Solid State Drive (SSD). The external memory 234 may further include a flash drive, for example, Compact Flash (CF), Secure Digital (SD), micro-SD, mini-SD, extreme Digital (xD), or a memory stick, etc. The external memory 234 may be operatively connected with the electronic device through various interfaces. According to one embodiment, the electronic device may further include a storage device (or a storage media) such as a hard drive.

The sensor module 240 may measure a physical quantity or sense an activation state of the electronic device, and convert measured or sensed information into an electric signal. The sensor module 240 may include, for example, at least one of a gesture sensor 240A, a gyro sensor 240B, an air pressure sensor 240C, a magnetic sensor 240D, an acceleration sensor 240E, a grip sensor 240F, a proximity sensor 240G, a color sensor 240H (e.g., a Red, Green, Blue (RGB) sensor), a biophysical sensor 240I, a temperature/humidity sensor 240J, an illumination sensor 240K, or a Ultraviolet (UV) sensor 240M. Additionally or alternatively, the sensor module 240 may include, for example, an E-nose sensor (not shown), an Electromyography (EMG) sensor (not shown), an Electroencephalogram (EEG) sensor (not shown), an Electrocardiogram (ECG) sensor (not shown), an Infrared (IR) sensor (not shown), an iris sensor (not shown), or a fingerprint sensor (not shown), etc. The sensor module 240 may further include a control circuit for controlling at least one or more sensors belonging therein.

The input device 250 may include a touch panel 252, a (digital) pen sensor 254, a key 256, or an ultrasonic input device 258. The touch panel 252 may, for example, detect a touch input in at least one of a capacitive overlay scheme, a pressure sensitive scheme, an infrared beam scheme, or an acoustic wave scheme. Also, the touch panel 252 may further include a control circuit as well. In a case of the capacitive overlay scheme, physical contact or proximity detection is possible. The touch panel 252 may further include a tactile layer as well. In this case, the touch panel 252 may provide a tactile response to a user.

The (digital) pen sensor 254 may be implemented in the same or similar method to receiving a user's touch input or by using a separate sheet for detection. The key 256 may include, for example, a physical button, an optical key, or a keypad. The ultrasonic input device 258 is a device capable of identifying data by sensing a sound wave in the electronic device through an input tool generating an ultrasonic signal and enables wireless detection. According to one embodiment, the electronic device may also use the communication module 220 to receive a user input from an external device (e.g., a computer or a server) connected with this.

The display 260 (e.g., the display 160) may include a panel 262, a hologram device 264, or a projector 266. The panel 262 may be, for example, a Liquid Crystal Display (LCD) or an Active-Matrix Organic Light-Emitting Diode (AMOLED), etc. The panel 262 may be, for example, implemented to be flexible, transparent, or wearable. The panel 262 may be constructed as one module along with the touch panel 252 as well. The hologram device 264 may use interference of light to show a three-dimensional image in the air. The projector 266 may project light to a screen to display an image. The screen may be, for example, located inside or outside the electronic device. According to one embodiment, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. Additionally or alternatively, the interface 270 may include, for example, a Mobile High-definition Link (MHL) interface, a Secure Digital (SD) card/Multi Media Card (MMC) interface or an Infrared Data Association (IrDA) standard interface.

The audio module 280 may convert a voice and an electric signal interactively. The audio module 280 may, for example, process sound information which is inputted or outputted through a speaker 282, a receiver 284, an earphone 286, or the microphone 288, etc.

The image sensor module 291 is a device able to take a still picture and a moving picture. According to one embodiment, the image sensor module 291 may include one or more image sensors (e.g., a front sensor or a rear sensor), a lens (not shown), an Image Signal Processor (ISP) (not shown), or a flash (not shown) (e.g., a Light Emitting Diode (LED) or a xenon lamp).

The power management module 295 may manage the power supply of the electronic device. Though not illustrated, the power management module 295 may include, for example, a Power Management Integrated Circuit (PMIC), a charger IC, or a battery or fuel gauge.

The PMIC may be, for example, mounted within an integrated circuit or a SoC semiconductor. A charging scheme may be divided into a wired charging scheme and a wireless charging scheme. The charger IC may charge the battery 296, and may prevent the inflow of overvoltage or overcurrent from an electric charger. According to one embodiment, the charger IC may include a charger IC for at least one of the wired charging scheme or the wireless charging scheme. The wireless charging scheme may, for example, be a magnetic resonance scheme, a magnetic induction scheme, or an electromagnetic wave scheme, etc. A supplementary circuit for wireless charging, for example, a circuit such as a coil loop, a resonance circuit, or a rectifier may be added.

The battery gauge may, for example, measure a level of the battery 296, a voltage during charging, a current or a temperature. The battery 296 may generate or store electricity, and use the stored or generated electricity to supply power to the electronic device. The battery 296 may include, for example, a rechargeable battery or a solar battery.

The indicator 297 may display a specific status of the electronic device or one part (e.g., the AP 210) thereof, for example, a booting state, a message state, or a charging state, etc. The motor 298 may convert an electric signal into a mechanical vibration. Though not illustrated, the electronic device may include a processing device (e.g., a GPU) for mobile TV support. The processing device for mobile TV support may, for example, process media data according to the standards of Digital Multimedia Broadcasting (DMB), Digital Video Broadcasting (DVB), or a media flow.

According to various embodiments of the present disclosure, an electronic device may insert an attribute variable (e.g., a tag) for selecting and displaying to at least one area of a web page selected by input information, thereby displaying a plurality of areas selected by a user on the web page.

According to various embodiments of the present disclosure, the electronic device may extract and store construction information of the at least partial area of the web page to which the attribute variable for selecting and displaying is inserted, thereby separately managing areas selected by the user.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which have been known or are to be developed hereinafter.

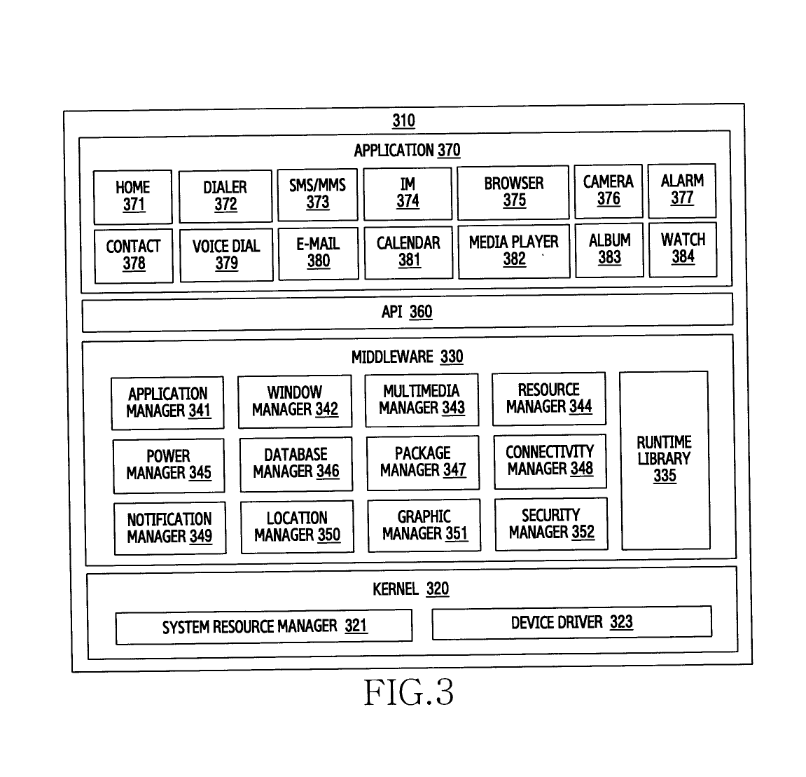

FIG. 3 is a diagram of an example of a program module, according to an embodiment of the present disclosure. As illustrated, a program module 310 (e.g., a program 140) may include an operating system for controlling resources associated with an electronic apparatus (for example, the electronic device 100) and/or various applications (for example, an application program 147) running on the operating system. The operating system may be, for example, Android, iOS, Windows, Symbian, Tizen, Bada, or the like.

The programming module 310 may include a kernel 320, middleware 330, an Application Programming Interface (API) 360, and/or an application 370. At least a part of the program module 310 can be preloaded on the electronic device or downloaded from the server.

The kernel 320 (for example, the kernel 141) may include, for example, a system resource manager 321 or a device driver 323. The system resource manager 321 may control, allocate, or collect the system resources. According to an embodiment, the system resource manager 321 may include a process management unit, a memory management unit, or a file system management unit. The device driver 323 may include, for example, a display driver, a camera driver, a Bluetooth driver, a shared-memory driver, a USB driver, a keypad driver, a Wi-Fi driver, an audio driver, or an Inter-Process Communication (IPC) driver. According to an embodiment, a WIFI driver of the kernel 320 may control at least one of an antenna mode or a transmission period of a network control message for use to transmit and receive signals to and from the communication interface 170.

The middleware 330 may provide, for example, a function commonly required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add new functions through a programming language while the application 370 is executed. The run time library 335 may perform input/output management, memory management, or a function for an arithmetic function.

The application manager 341 may manage, for example, a life cycle of at least one of the applications 370. The window manager 342 may manage Graphical User Interface (GUI) resources used by a screen. The multimedia manager 343 may grasp formats required for the reproduction of various media files, and may perform an encoding or decoding of the media file by using a codec suitable for the corresponding format. The resource manager 344 may manage resources such as a source code, a memory, and a storage space of at least one of the applications 370.

The power manager 345 may operate together with a Basic Input/Output System (BIOS) to manage a battery or power and may provide power information required for the operation of the electronic device. The database manager 346 may generate, search for, or change a database to be used by at least one of the applications 370. The package manager 347 may manage the installation or the updating of applications distributed in the form of a package file.

The connectivity manager 348 may manage various types of wireless connections, such as Wi-Fi or Bluetooth connections. The notification manager 349 can display or notify of an event such as an arrival message, promise, proximity notification, and the like in such a way that does not disturb a user. The location manager 350 may manage location information of the electronic device. The graphic manager 351 may manage graphic effects to be provided to a user and user interfaces related to the graphic effects. The security manager 352 may provide all security functions required for system security or user authentication.

According to an embodiment, the middleware 330 may control at least one of the transmission period of an antenna mode or a transmission period of a network control message for use to transmit and receive signals to and from the communication interface 170 by using at least one manager.

According to an embodiment, when the electronic device (for example, electronic device 100) has a call function, the middleware 330 may further include a telephony manager for managing a voice call function or a video call function of the electronic device.

The middleware 330 may include a middleware module for forming a combination of various functions of the aforementioned components. The middleware 330 may provide modules specialized according to types of operating systems in order to provide differentiated functions. Further, the middleware 330 may dynamically remove some of the existing components or add new components.

The API 360 (for example, the API 145) is, for example, a set of API programming functions, and a different configuration thereof may be provided according to an operating system. For example, with respect to each platform, one API set may be provided in a case of Android or iOS, and two or more API sets may be provided in a case of Tizen.

The applications 370 (for example, the application programs 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment, the application 370 may include an application (hereinafter, for ease of explanation, “Information Exchange application”) that supports the exchange of information between the electronic device (for example, the electronic device 100) and the external electronic device. The application associated with exchanging information may include, for example, a notification relay application for notifying an external electronic device of certain information or a device management application for managing an external electronic device.

For example, a notification relay application may include a function of transferring the notification information generated by other applications of the electronic device (for example, SMS/MMS application, an e-mail application, a healthcare application, or an environmental information application, etc.) to the external electronic device. Further, the notification relay application may receive notification information from, for example, the external electronic device and provide the received notification information to the user. For example, the device management application may manage (e.g., install, delete, or update) at least one function (e.g., turning on/off the external electronic device itself (or some elements thereof) or adjusting the brightness (or resolution) of a display) of the external electronic device communicating with the electronic device, applications operating in the external electronic device, or services (e.g., a telephone call service or a message service) provided by the external electronic device.

According to an embodiment, the application 370 may include an application (for example, a health management application) specified according to an attribute (for example, as an attribute of the electronic device, the type of electronic device is a mobile medical equipment) of the external electronic device. According to an embodiment, the application 370 may include an application received from the external electronic device (for example, a server or an electronic device). According to an embodiment, the applications 370 may include a preloaded application or a third party application which can be downloaded from the server. The names of the elements of the program module 310, according to the embodiment illustrated in FIG. 3, may vary according to the type of operating system.

According to various embodiments, at least a part of the programming module 310 may be implemented in software, firmware, hardware, or a combination of two or more thereof. At least a part of the program module 310 can be implemented (e.g., executed), for example, by a processor (for example, by an application program). At least some of the program module 310 may include, for example, a module, program, routine, sets of instructions, or process for performing one or more functions.

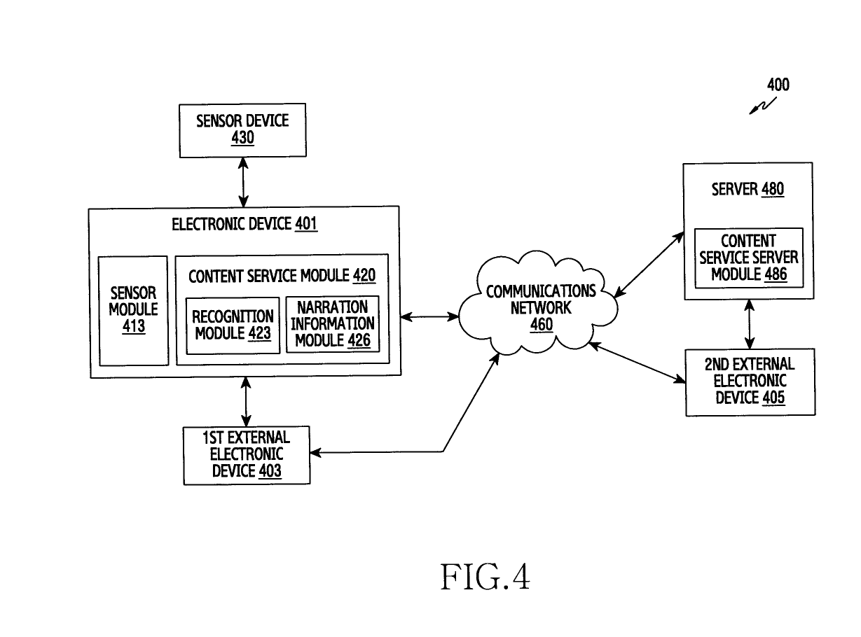

FIG. 4 is a diagram of an example of a network environment, according to an embodiment of the present disclosure.

Referring to FIG. 4, the network environment 400 may include an electronic device 401, a first external electronic device 403, a second external electronic device 405, a sensor device 430, a communications network 460, and a server 480. According to one embodiment, the electronic device 401 may connect with at least one of the first external electronic device 403, the second external electronic device 405, the sensor device 430, or the server 480, and provide a service associated with content to at least one user. For example, the service associated with the content may include a change of one portion of the content, sharing of the content, generation of narration information corresponding to the content, or recognition of an object included in the content, etc.

According to one embodiment, the electronic device 401 may include a sensor module 413 (e.g., the sensor module 240) and a content service module 420. For example, the sensor module 413 may include at least one of various sensors such as an image sensor (e.g., the camera module 291) for sensing an image, a motion sensing sensor (e.g., the acceleration sensor 241E or the gyro sensor 240B, etc.) for sensing a motion of the electronic device 401, an environment information sensor (e.g., the temperature/humidity sensor 240J, the illumination sensor 240K, etc.) for sensing environment information such as a temperature, a humidity, an illumination, an air pressure, or a smell around the electronic device 401, a biophysical sensor (e.g., the biophysical sensor 240I, etc.) for sensing biophysical information such as user's blood pressure, hematocele, iris, brain wave, blood sugar, oxygen saturation, or fingerprint, etc., a grip sensor (e.g., the grip sensor 240F), a proximity sensor (e.g., the proximity sensor 240G), a touch sensor (e.g., the touch panel 252), a pen sensor (e.g., the pen sensor 254), or an audio sensor (e.g., the microphone 288, etc.), etc.

According to one embodiment, the content service module 420 may use the sensor module 413, to acquire content or information associated with the content. Or, the content service module 420 may use the first external electronic device 403, the second external electronic device 405, the sensor device 430, the communications network 460, or the server 480, to acquire content or information associated with the content. For instance, the content service module 420 may identify information (e.g., identification information or request information associated with an external device, etc.) received from an external device (e.g., the first and second external electronic devices 403 and 405, the sensor device 430, the communications network 460, or the server 480), in association with the content. Based on at least a part of the received information, the content service module 420 may provide a service associated with content (e.g., a change of at least one portion of the content, narration information provision, or object identification, etc.). According to one embodiment, the information associated with the content may include information that the electronic device 401 identifies in order to provide a service associated with the content.

According to one embodiment, the content service module 420 may receive information from an external device (e.g., the first external electronic device 403 or the sensor device 430) or transmit information to the external device, through a communication module (e.g., the communication module 220). For example, the content service module 420 may acquire information associated with content from a sensor module of the external device or a memory thereof. According to one embodiment, the content service module 420 may control a camera module operatively connected to the external device. The content service module 420 may acquire content through the camera module operatively connected to the external device. For instance, the content service module 420 may directly control the camera module operatively connected to the external device, or request content acquisition to the external device through the camera module. According to one embodiment, the content service module 420 may provide a service associated with content. For example, the content service module 420 may display content through a display module operatively connected to the external device. For instance, the content service module 420 may directly control the display module operatively connected to the external device, or request the external device for content display.

According to one embodiment, the content service module 420 may use information associated with content, to analyze the content. For example, the content service module 420 may use information (e.g., identification information or position information, etc.) received from an external device (e.g., the first external electronic device 403), to analyze whether content includes information associated with the external device. For instance, if receiving a signal (e.g., a discovery signal or beacon, etc.) corresponding to the external device in a position related with content acquisition, the content service module 420 may use at least a part of the signal corresponding to the external device, to determine if the content includes the information (e.g., user's voice or image, etc.) associated with the external device. Or, the content service module 420 may use the information associated with the content, to generate narration information (e.g., a text, an image, or an audio, etc.) corresponding to the content. For instance, when generating or changing content, the content service module 420 may determine an adjacent external device, and reflect the determination result to decide narration information (e.g., a description or story) about the content. Or, the content service module 420 may analyze content, and recognize information corresponding to the external device in the content.

According to one embodiment, the content service module 420 may include a recognition module 423. Based on information received from an external device, the recognition module 423 may, for example, recognize at least one object included in a particular content. For instance, the recognition module 423 may use identification information received from the external device, to preferentially recognize an object (e.g., a user of the external device) corresponding to the external device in content. According to one embodiment, the recognition module 423 may use at least one of the first external electronic device 403 or the server 480, to recognize at least one object in one or more contents. For example, the recognition module 423 may interwork with the first external electronic device 403, to recognize at least one object in content.

According to one embodiment, the recognition module 423 may include a feature extracting module or a feature matching module. For example, the feature extracting module may extract one or more features from content. For instance, the feature extracting module may extract at least one of frequency information associated with at least one object, a waveform, a pitch, a feature vector, an eigenface, a skin pattern, a facial geometry, a thermogram, a motion vector, edge information, line information, costume information, or a dynamic facial expression feature, from content (e.g., an audio, an image, or a video).

According to one embodiment, the feature matching module may use at least one or more databases, to determine information or object corresponding to one or more features. For example, the feature matching module may use a feature extracted from the feature extracting module, to compare the extracted feature with information of a database and recognize one or more objects. According to one embodiment, the feature matching module may include various feature matching modules such as neural networks, a hidden Markov model, deep learning, or maximum likelihood, etc.

According to one embodiment, the recognition module 423 may include at least one or more object recognition databases. The object recognition database may provide information for object recognition. For example, the object recognition database may include recognition information (e.g., a user of the electronic device 401 or an object recognized in the electronic device 401, etc.) related to the electronic device 401.

According to one embodiment, the recognition module 423 may recognize object information corresponding to an object included in content or additional information corresponding to the content. For example, the object information, which is information associated with the object, may include at least one of identification information corresponding to the object, position information, or attribute information. For instance, the recognition module 423 may identify a user or object included in content, through voice recognition or face recognition. Or, the recognition module 423 may recognize positions of respective objects in content. Or, the recognition module 423 may recognize a look or emotion of a user included in content. According to one embodiment, the additional information may include information additionally identified in relation with an object. For example, the additional information may include at least one of SNS information, device service information, calorie information, nutrition information, or location-based service information. According to one embodiment, the object information may include additional information.

According to one embodiment, the recognition module 423 may use a content service server module 486 of the server 480, to recognize object information or additional information corresponding to an object included in content. For example, the recognition module 423 may use a database (e.g., a database of a server) available in the server 480, to recognize object information or additional information. For instance, the recognition module 423 may transmit a request for recognition of content to the server 480.

According to one embodiment, the recognition module 423 may use the first external electronic device 403, to recognize object information or additional information. For example, the recognition module 423 may transmit a request for recognition of content to the first external electronic device 403. For instance, the content recognition request may include information extracted from the feature extracting module. Or, the content recognition request may include at least a part of content. According to one embodiment, based on the content recognition request, the first external electronic device 403 may recognize object information or additional information corresponding to an object included in content, and provide a response to the recognition module 423. Additional information about the recognition request is provided through [Table 1] described later.

According to one embodiment, the recognition request may include a recognition request referring to [Table 1]. For example, the recognition module 423 may transmit at least one recognition request to the external device, in accordance with a designated condition.

TABLE 1

| Type | Request type | Included information |
|---|---|---|
| 1 | Designated | The entire content or parts of |
| | recognition request | the content or information |
| | (Find you) | corresponding thereto |
| 2 | Designated | At least partial content or |
| | recognition request | information corresponding |
| | (Is that you?) | thereto |
| 3 | Expanded | The entire content or parts of |
| | recognition request | the content or information |
| | (Find anyone) | corresponding thereto |
| 4 | Designated | At least partial content or |
| | recognition request | information corresponding |
| | (Is that you?) | thereto |

According to one embodiment, a first type recognition request of [Table 1] may include information in which the electronic device 401 requests an external device (e.g., the first external electronic device 403) to recognize information (e.g., information associated with a user of an external device) associated with the external device in content (e.g., an image or an audio, etc.). For example, the first type recognition request may include the entire content or parts (e.g., multiple faces or multiple audio durations) of the content. Or, the first type recognition request may include information (e.g., an eigenface or sound wave signature, etc.) corresponding to at least a part of the content. For example, based on the first type recognition request, the first external electronic device 403 may recognize information (e.g., the user or the first external electronic device 403) associated with the first external electronic device 403. The first external electronic device 403 may respond the recognized information to the electronic device 401. Based on the response, the electronic device 401 may acquire object information or additional information corresponding to an object associated with the first external electronic device 403 included in the content.

According to one embodiment, a second type recognition request of [Table 1] may include information in which the electronic device 401 recognizes information (e.g., information corresponding to an external device or a user of the external device) associated with the external device (e.g., the first external electronic device 403) in content, and requests the external device for additional recognizing (e.g., checking or verifying) of the recognized information. For example, the second type recognition request may include at least a partial content (e.g., at least a partial content recognized as the user of the external device). Or, the second type recognition request may include information (e.g., eigenface or sound wave signature, etc.) corresponding to the at least partial content. The electronic device 401 may use a response to the second type recognition request received from the external device, to acquire object information or additional information corresponding to an object associated with the external device included in the content.

According to one embodiment, a third type recognition request of [Table 1] may include information in which the electronic device 401 requests an external device (e.g., the first external electronic device 403 or the server 480) for object recognition in content (e.g., an image or an audio). For example, the third type recognition request may include the entire content or parts (e.g., multiple faces or multiple audio durations) of the content. Or, the third type recognition request may include information (e.g., eigenface or sound wave signature, etc.) corresponding to at least a part of the content. The electronic device 401 may use a response to the third type recognition request received from the external device, to acquire object information or additional information corresponding to at least one object included in the content. According to one embodiment, the electronic device 401 may use the third type recognition request, to recognize an object failed to be recognized by using the object recognition database of the electronic device 401.

According to one embodiment, a fourth type recognition request of [Table 1] may include information in which the electronic device 401 recognizes at least one object in content, and requests an external device (e.g., the first external electronic device 403 or the server 480) for additional recognizing (e.g., checking or verifying) of the recognized object. For example, the fourth type recognition request may include at least a partial content (e.g., at least a partial content recognized as at least one object). Or, the fourth type recognition request may include information (e.g., eigenface or sound wave signature, etc.) corresponding to the at least partial content. The electronic device 401 may use a response to the fourth type recognition request received from the external device, to acquire object information or additional information corresponding to at least one object included in the content.

According to one embodiment, the electronic device 401 may acquire content, and transmit a recognition request to at least one external device (e.g., the first external electronic device 403, the second external electronic device 405, or the server 480). For example, the electronic device 401 may transmit the recognition request to the adjacent first external electronic device 403 through short-range wireless communication. For instance, the electronic device 401 may transmit the recognition request to the first external electronic device 403 located in a direction (e.g., a photographing direction or a recording direction, etc.) associated with the content, through a directive communication technique. Or, the electronic device 401 may transmit the recognition request to a designated external device (e.g., the second external electronic device 405), through the server 480.

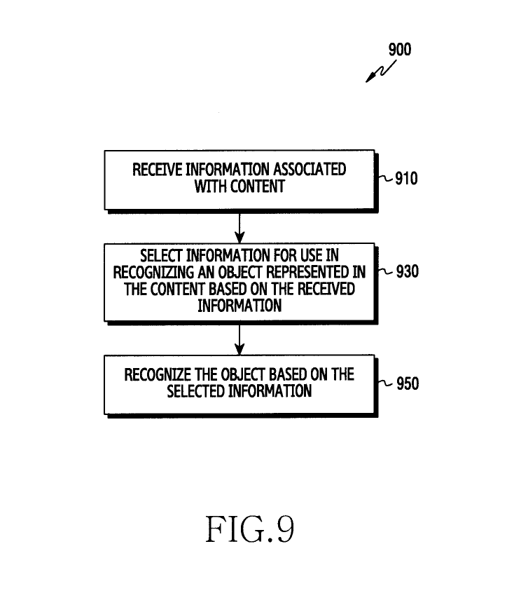

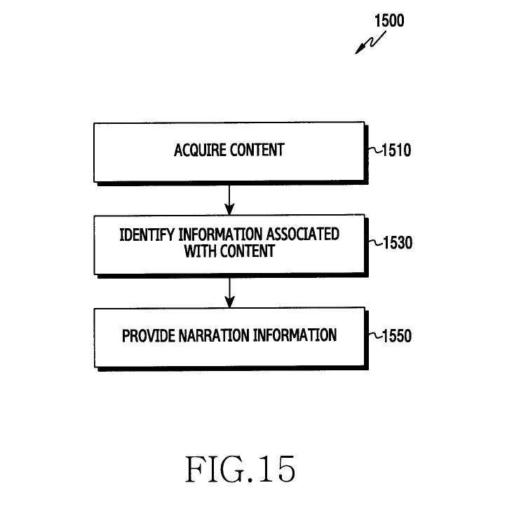

According to one embodiment, if a designated condition is satisfied, the electronic device 401 may transmit a request for recognition of content to an external device. For example, the designated condition may include a case that the electronic device 401 fails to recognize at least one object included in content using the recognition module 423, for example, a case that a matching probability is less than a designated probability. Or, the designated condition may include a case that the electronic device 401 identifies a device located in proximity to the sensor module at a time point (e.g., a time point of image photographing or a time point of audio acquisition) when the sensor module operatively connected to the electronic device 401 acquires content. Or, the designated condition may include a case that the electronic device 401 determines that at least one external device is associated with content. Or, the designated condition may include a case that the electronic device 401 uses the recognition module 423 to recognize object information or additional information, and needs checking the recognition result. Or, the designated condition may include different various conditions. Additional information about object recognition is provided with reference to FIG. 9 or FIG. 15.

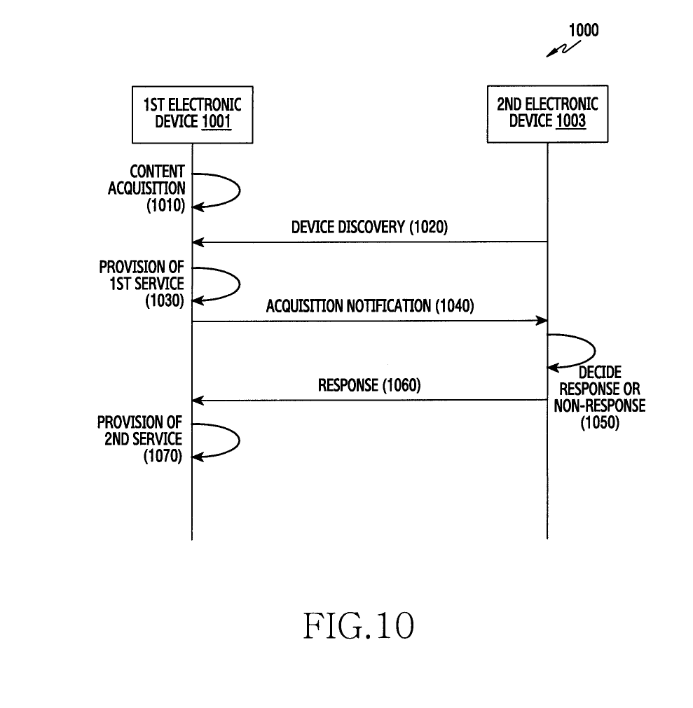

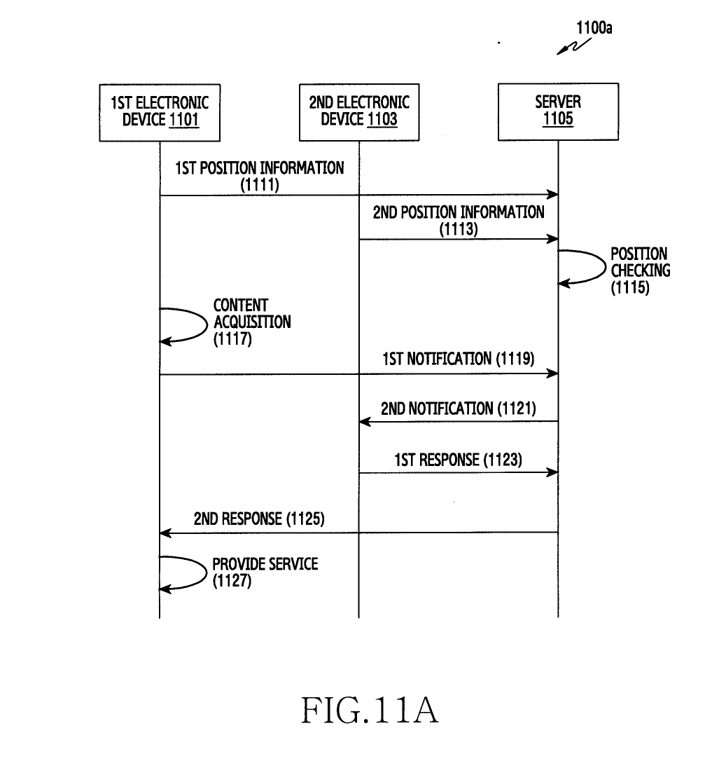

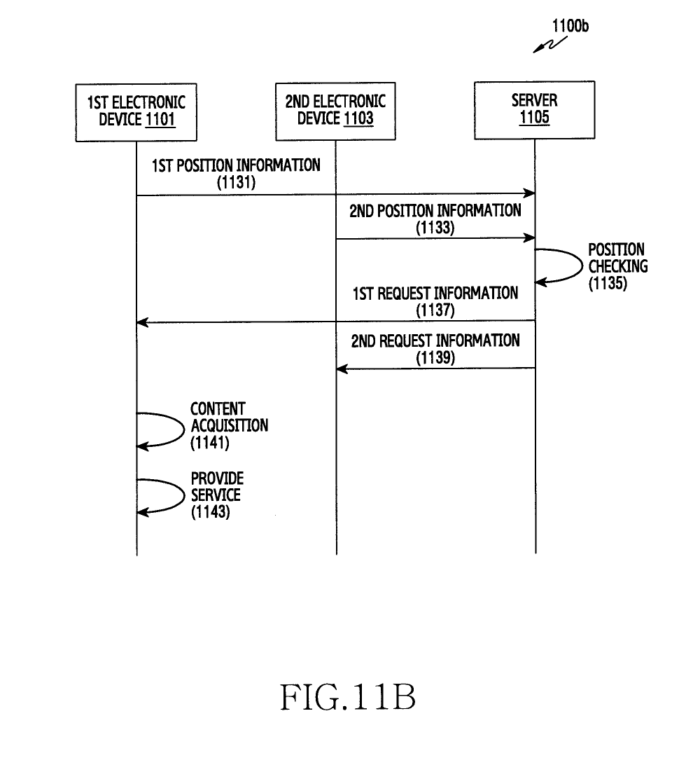

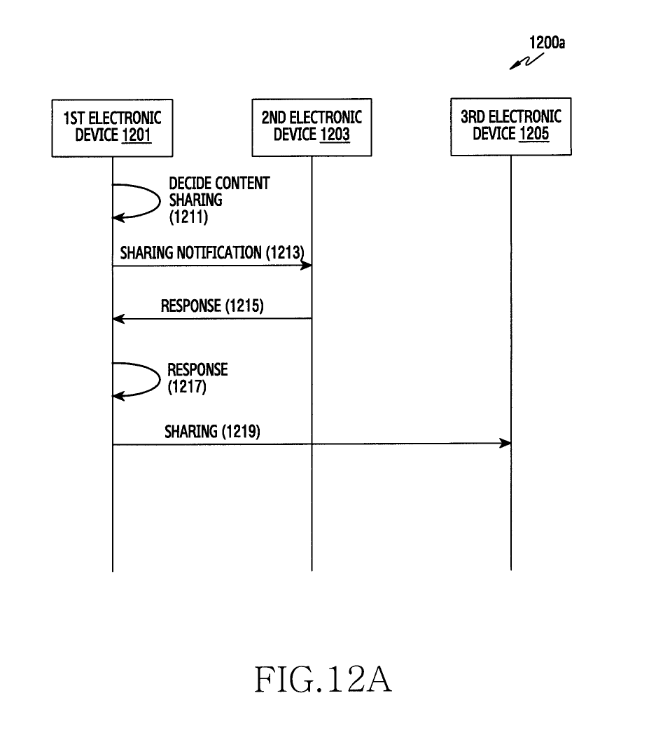

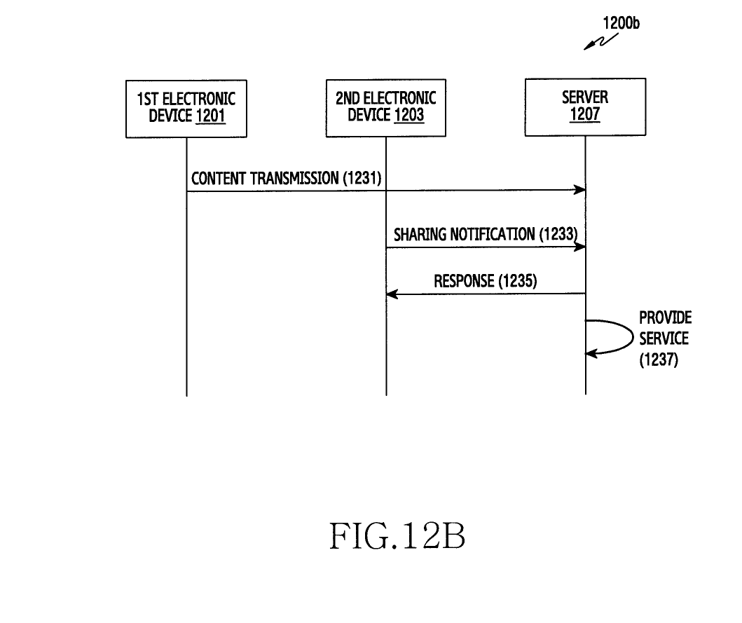

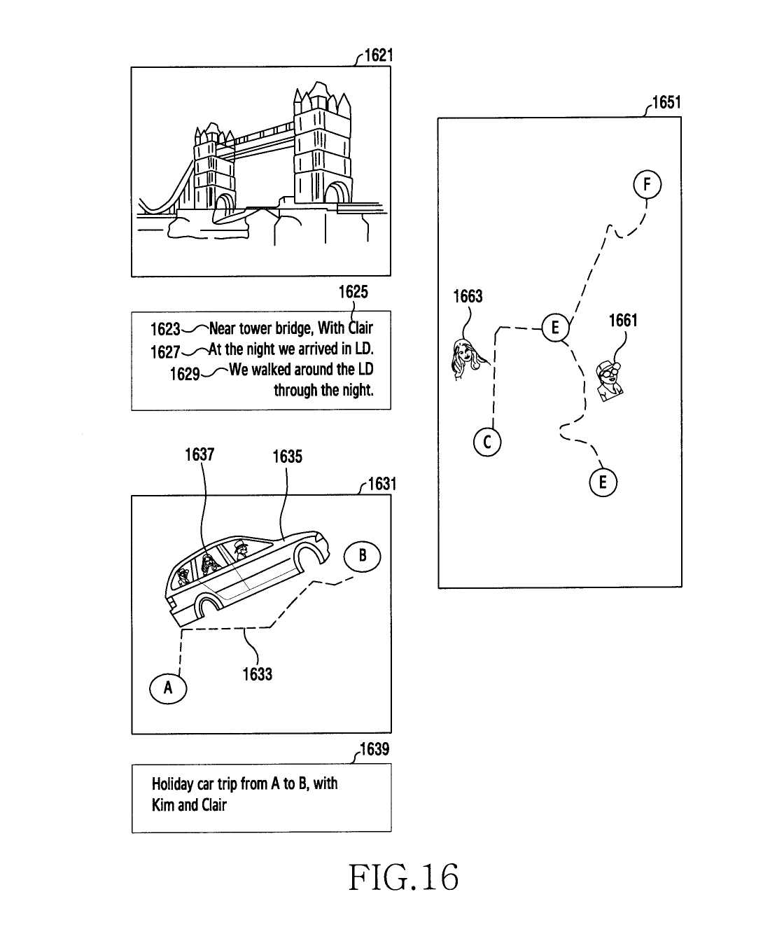

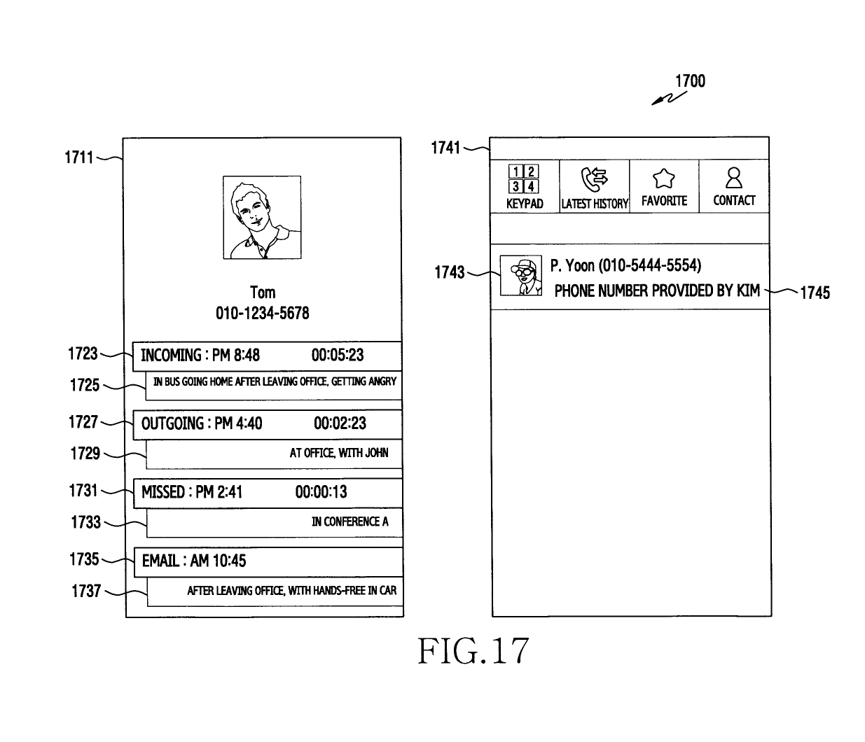

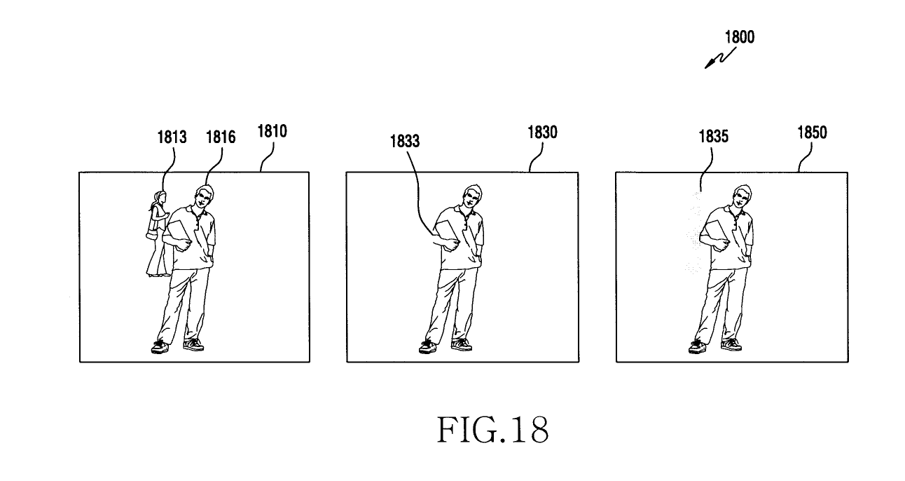

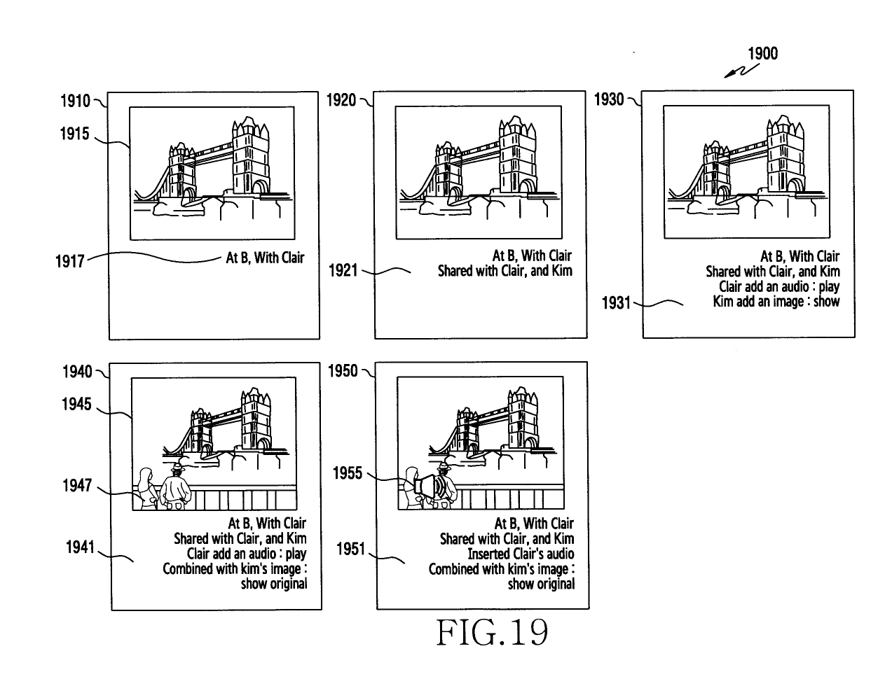

According to one embodiment, the content service module 420 may include a narration information module 426. For example, the narration information module 426 may use at least a part of information received from an external device, to provide narration information corresponding to content. The narration information module 426 may the narration information, as discussed with respect to FIG. 15, FIG. 16, FIG. 17, or FIG. 19. Or, the content service module 420 may share at least a part of content with the external device, based on sharing information received from the external device. The content service module 420 may provide additional information about sharing with reference to FIG. 12. Or, the content service module 420 may change or delete at least a part of content, based on privacy protection information received from the external device. According to one embodiment, the privacy protection information may include a request (e.g., an acquisition notification request, a deletion request, a sharing request, or a change request, etc.) of the external device for content including information corresponding to a user of the external device. Additional information about the privacy protection information is provided with reference to FIG. 10, FIG. 11, or FIG. 18.

According to one embodiment, the electronic device 401 may acquire an analog signal through the sensor module 413 (e.g., the camera module 291), and acquire content (e.g., an image) through content processing (e.g., image processing). For example, the sensor module 413 may include at least one circuit or processor (e.g., an image signal processor) for content processing. The sensor module 413 may process content while acquiring information corresponding to at least one of black level compensation, auto white balance, auto exposure, lens shading, edge extraction, color correction, noise reduction, scalar or codec, and store the acquired information in association with the content. For example, the sensor module 413 may acquire various information such as black level reference, external lighting environment, entire-image average brightness, brightness measurement associated with a portion of the image, image position brightness level information, high frequency information, color distortion information, noise strength, noise kind, or motion vector information, edge information, etc., and store the acquired at least one information in association with the content. In some implementations, the sensor module 413 may store the information in the content as metadata.

According to one embodiment, the sensor module 413 may include an optical image stabilizer or a digital image stabilizer. For example, the digital image stabilizer may eliminate or decrease shaking of content, based on at least one of motion information associated with the sensor module 413 or shaking information of the content. For example, based on this, the digital image stabilizer may generate motion information, shaking information, or stabilization information, as information associated with the content. According to one embodiment, the content service module 420 may use the information associated with the content, to change the content (e.g., change the entire content or change only a portion of the content). For example, the content service module 420 may use the edge information, to change a resolution of the content. Or, the content service module 420 may use the motion information, to remove blurring in the content. Or, the content service module 420 may use external lighting environment information, to change a color of the content. According to one embodiment, the content service module 420 may receive information associated with content from an external device. For instance, the content service module 420 may receive edge information of the content from the content service server module 486 of the server 480, and change a resolution of the content.

According to one embodiment, the content service module 420 may acquire external device information, data to be added to content, reaction information associated with the content, schedule information, intimacy information, or recognition information associated with the content, from an external device (e.g., the first external electronic device 403). Additionally or alternatively, the content service module 420 may receive information associated with various contents such as device information (e.g., the first external electronic device 403) located in proximity to the electronic device 401, weather information, traffic information, or area information, etc., from the external device (e.g., the communications network 460 or the server 480). Additionally or alternatively, the content service module 420 may receive information associated with various contents such as a reaction to the contents, a command, a request, or information to be added to the contents, etc., from an external device (e.g., the server 480).

According to one embodiment, the content service module 420 may use information associated with content, to provide a service associated with the content. For example, the content service module 420 may use the information associated with the content, to change the content (e.g., deletion, blur, synthesis, rate change, animation provision, interpolation, or sharpening). Changing the content may include changing the entire content or a portion of the content. Additionally or alternatively, the content service module 420 may use the information (e.g., a sharing request) associated with the content, to transmit at least a part of the content to an external device. Additionally or alternatively, the content service module 420 may add additional information (e.g., an audio, an image, a text, or a video, etc.) to the content. Additionally or alternatively, the content service module 420 may use the information (e.g., recognition information) associated with the content, to recognize an object included in the content. Additionally or alternatively, the content service module 420 may generate and provide narration information corresponding to the content. For example, the content service module 420 may use a narration information table, to generate the narration information. According to one embodiment, the electronic device 401 may provide the narration information at least in part through the electronic device 403 or the server 480 (e.g., the content service server module 486).

According to one embodiment, the first and second external electronic devices 403 and 405 may be devices of the same or different type as the electronic device 401, respectively. According to one embodiment, all or some operations executed in the electronic device 401 may be executed in other one or more electronic devices (e.g., the first external electronic device 403, the second external electronic device 405, or the server 408).

According to one embodiment, the first external electronic device 403 may transmit information (e.g., information associated with content) to the electronic device 401 through short-range wireless communication (e.g., Bluetooth, NFC, etc.). The information may be contained in any suitable type of signal, such as a discovery signal, an advertisement signal, a beacon signal, or a data signal, etc. Additionally or alternatively, the first external electronic device 403 may transmit information to the electronic device 401 through various wireless communication such as Wireless Fidelity (Wi-Fi), Wireless Gigabit alliance (WiGig), Bluetooth, Light Fidelity (Li-Fi), ultrasonic communication, or Long Term Evolution (LTE) direct, etc. According to one embodiment, the second external electronic device 405 may transmit information to the electronic device 401 through the communications network 460 or the server 480.

According to one embodiment, the first external electronic device 403 may include a recognition module and an object recognition database. The first external electronic device 403 may be operatively connected to the server 480, and use or interwork with the server 480 to recognize at least one object that is represented in content. According to one embodiment, the object recognition database of the first external electronic device 403 may include more information (e.g., information corresponding to a user of the first external electronic device 403) related to the first external electronic device 403 than an object recognition database of the electronic device 401. According to one embodiment, the object recognition database of the second external electronic device 405 may include more information related to the second external electronic device 405 than an object recognition database of the electronic device 401.

According to one embodiment, the sensor device 430 may include at least one sensor of the same or different type as the sensor module 413. According to one embodiment, the sensor device 430 may include at least one of a wearable device (e.g., a watch, a necklace, glasses, or a tattoo, etc.), a sensor network (e.g., a temperature/humidity sensor, an intrusion sensor, or an earthquake sensor, etc.), a vehicle network, or a home network device (e.g., an air conditioner, a TV, a cleaner, a refrigerator, a washing machine, an air conditioner, a heater, a ventilator, or an additional control device thereof, etc.). In various embodiments of the present disclosure, the sensor device 430 may be one of the aforementioned various devices or a combination of two or more. Also, the sensor device 430 is not limited to the aforementioned devices, and may suitable type of device. For example, the sensor device 430 may provide various sensor information to the electronic device 401. The sensor device may be connected to the electronic device via any suitable type of switch and/or non-switched connection (e.g., Bluetooth, TCP/IP, etc.)

According to one embodiment, the communications network 460 may include an LTE network, a mobile World interoperability for microwave access (WiMAX) network, a Code Division Multiple Access (CDMA) 1x network, a Wideband CDMA (WCDMA) network, a Wi-Fi network, or Global System for mobile communications (GSM) network, etc. Or, the communications network 460 may include a Fiber To The Office (FTTO), a Fiber To The Home (FTTH), a Passive Optical Network (PON), or a Digital Subscriber Loop (DSL), etc. According to one embodiment, at least one entity (e.g., a mobility management entity of LTE, a Mobility Management Entity (MME), or a home subscriber server, etc.) of the communications network 460 may provide various information (e.g., position information or information of an electronic device located around, etc.) related to the electronic device 401 or various services associated with content, to the electronic device 401.

According to one embodiment, the server 480 may include various servers such as a Social Network Service (SNS) server, a home network server (e.g., a personal computer, a TV, etc.), a storage device, a distributed computing device, or a content delivery network server, etc. Or, the server 480 may include at least one entity of the communications network 460, for example, a Wi-Fi Access Point (AP), an LTE enhanced Node B (eNode B), an LTE MME, an authentication server, an authorization server, or an accounting server. Or, the server 480 may include at least one entity of an IP Multimedia Subsystem (IMS), for example, an application server, a presence server, a resource list server, an XML document management server, a media server, or a Home Subscriber Server (HSS). Or, the server 480 may include an electronic device connectable through the Internet.

According to one embodiment, the server 480 may include the content service server module 486. For example, the content service server module 486 may provide a service associated with content to the electronic device 401, the first external electronic device 403, or the second external electronic device 405. According to one embodiment, the content service server module 486 may receive content or information associated with the content, from another device. The content service server module 486 may use information (e.g., privacy protection information) associated with the content, to change the content (e.g., change the entire content or portion thereof). For example, based on a request for change or deletion of at least part of content received from an external device, the content service server module 486 may provide a change or deletion of the at least part of the content. According to one embodiment, the convent service server module 486 may add additional information (e.g., an audio, an image, a text, or a video, etc.) to the content. Or, the content service server module 486 may generate and provide various narration information about the content.

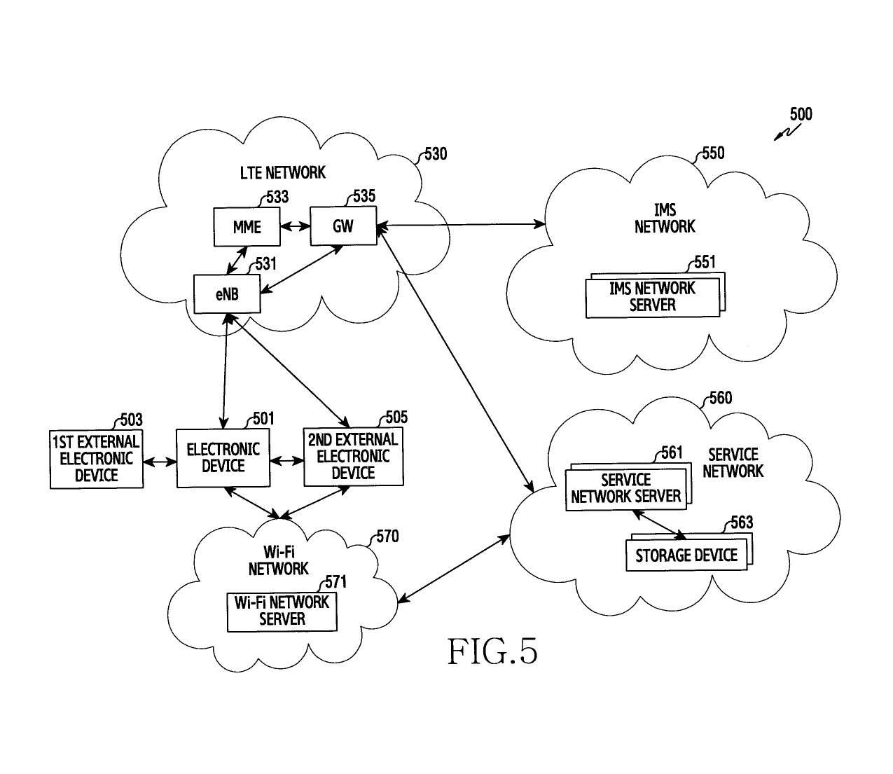

According to one embodiment, the content service server module 486 may provide object recognition information to another device (e.g., the electronic device 401, etc.). For example, the content service server module 486 may include a module such as the recognition module 423. For example, the content service server module 486 may process content received from an external device, to recognize an object represented by the content. For instance, the content service server module 486 may receive content including an image or video, and recognize a person or physical object that is depicted in the content. Or, the content service server module 486 may receive content including an image or video, and recognize information (e.g., schedule information, SNS information, or narration information, etc.) related to a figure or thing included in the content. Or, the content service server module 486 may receive content including audio, and process to identify at least one of the identity of a speaker, an emotion (or mood) of the speaker. In some implementations, the content service server module 486 may use natural language recognition to identify the topic, or subject matter of the audio. Additional information about the server 486 is provided with reference to FIG. 5.

FIG. 5 is a diagram of an example of a network environment, according to an embodiment of the present disclosure.

Referring to FIG. 5, the network environment 500 may include an electronic device 501 (e.g., the electronic device 401), a first external electronic device 503 (e.g., the first external electronic device 403), a second external electronic device 505 (e.g., the second external electronic device 405), an LTE network 530, an IMS network 550, a service network 560, or a Wi-Fi network 570. According to one embodiment, the electronic device 501 may be connected to the first external electronic device 503, the second external electronic device 505, the LTE network 530, the IMS network 550, the service network 560, or the Wi-Fi network 570, and provide a service associated with content to at least one user.

According to one embodiment, the LTE network 530 (e.g., the communications network 460) may include entities such as an eNB 531, an MME 533, and a gateway (GW) 535, etc. The eNB 531 may be a device (e.g., a base station) providing a wireless interface (or wireless connection) between at least one user device (e.g., the electronic device 501) and the LTE network 530. For example, the eNB 531 may control a wireless connection with the electronic device 501 or the second external electronic device 505, and control a wireless resource (e.g., a frequency) allocated to the wireless connection. The MME 533 may manage connection and position of at least one user device connected through the eNB 531. For example, the MME 533 may provide an authentication service when the electronic device 501 or second external electronic device 505 gains access to the LTE network 530, or track or manage the mobility of the electronic device 501 or second external electronic device 505 and provide a service to the electronic device 501 or second external electronic device 505. The gateway 535 may include a Serving gateway (S-GW) and a Public data network gateway (P-GW). For example, the gateway 535 may route packets communicating with the LTE network 530 and an external communication network (e.g., the IMS network 550 or the service network 560), or provide a fireall, or allocate an address (e.g., an IP address) to at least one user device. According to one embodiment, at least one entity of the LTE network 530 may include a device such as the aforementioned server (480 of FIG. 4).

According to one embodiment, the IMS network 550 may include entities such as a Call Session Control Function (CSCF) and an IMS network server 551 (e.g., an application server or a presence server, etc.), etc. For example, the CSCF may include at least one of a Proxy Call Session Control Function (P-CSCF), a Serving Call Session Control Function (S-CSCF), or an Interrogating Call Session Control Function (I-CSCF). For example, the IMS network server 551, which is a device for supporting a service provided through the IMS network 550, may include, for example, a Telephony Application Server (TAS) or a Voice Call Continuity (VCC) server. According to one embodiment, the IMS network server 551 may include a device such as the aforementioned server (480 of FIG. 4).

According to one embodiment, the IMS network server 551 (e.g., the server 480) may provide a service associated with content, to the electronic device 501 or second external electronic device 505. For example, the IMS network server 551 may provide information about an adjacent electronic device to at least one of the electronic device 501 or the second external electronic device 505, based on the current position of the electronic device 501 or second external electronic device 505. For instance, if the electronic device 501 acquires content, the IMS network server 551 may provide information related to content acquisition of the electronic device 501, to an external device (e.g., the second external electronic device 505) located adjacent to the electronic device 501.

According to one embodiment, if the electronic device 501 acquires content, the IMS network server 551 may provide information (e.g., privacy protection information) associated with a content request from another device located adjacently to the electronic device 501. Additionally or alternatively, if the electronic device 501 may share content associated with the second external electronic device 505, with another device (e.g., the first external electronic device 503), the IMS network server 551 may provide sharing information of the corresponding content to the second external electronic device 505. For example, the sharing information may indicate that content stored in the electronic device 501 is provided to the other device, or, inversely, content stored in the other device is provided to the electronic device 501. For example, the sharing may be implemented through an operation in which the electronic device 501 transmits/receives specific content from/to the other device, or the IMS network server 551 provides specific content to at least one of the electronic device 501 or the other device.

According to one embodiment, the electronic device 501 may use a service (e.g., a Rich Communication Suit (RCS)) of the IMS network 550, to receive information (e.g., a status, a geolocation, capabilities, availability, willingness, an image, or a video, etc.) associated with the second external electronic device 505. According to one embodiment, the electronic device 501 may use the received information, to provide a service associated with content.

According to one embodiment, the service network 560 may include one or more of a social network, a cloud service network, a distributed computing network, a content providing network, or a service portal. For example, the service network 560 may include a service network server 561 (e.g., the server 480) and a storage device 563 (e.g., a data center). For example, the service network server 561 may use content or information stored in the storage device 563, to provide various services to the electronic device 501, the first external electronic device 503, or the second external electronic device 505.

For example, the service network server 561 may use at least a part of information corresponding to the electronic device 501 stored in the storage device 563, to provide a service (e.g., friend recommendation, narration information provision, health care, life logging, content change, or privacy protection) to the electronic device 501 or a user of the electronic device 501. For instance, the service network server 561 may analyze information corresponding to the electronic device 501 stored in the storage device 563, and/or provide to the electronic device 501 information associated with another electronic device (e.g., external electronic device) or the user of the other electronic device. By way of example, the information associated with the other electronic device may include position information (e.g., a daily movement path, a monthly movement path, a residence, a company, or a frequently visiting location, etc.). Additionally or alternatively, the service network server 561 may use the association (e.g., a time, a position, or a social relationship of a user, etc.) between a first content of the electronic device 501 and a second content of the electronic device 503, to associate the first content and the second content as one group and provide a service associated with the content. For instance, the service network server 561 may associate the first content and the second content as one event (e.g., a trip or party, etc.), and provide narration information corresponding to the event.

According to one embodiment, if receiving content from the electronic device 501, the service network server 561 may determine if the content includes information (e.g., a face of a user of the first external electronic device 503) corresponding to the first external electronic device 503, and modify the content, based on privacy protection information of the first external electronic device 503. In some implementations, modifying the content may include changing or deleting part of the content. Also, the service network server 561 may provide a content notification to the first external electronic device 503.

According to one embodiment, the Wi-Fi network 570 may include a Wi-Fi network server 571. For example, the Wi-Fi network 570 may connect the electronic device 501 and the second external electronic device 505. Or, the Wi-Fi network 570 may connect the electronic device 501 or second external electronic device 505 with the service network 560. According to one embodiment, the Wi-Fi network server 571 may include various devices such as a Wi-Fi access point, a home server, a home gateway, a PC, a TV, a tablet, or a car, etc. For example, the Wi-Fi network server 571 may include a device such as the aforementioned server (480 of FIG. 4) or the electronic device (401 of FIG. 4). Referring to FIG. 5, for description convenience, an embodiment including the Wi-Fi network 570 is disclosed, but it is not limited to this, and various embodiments of the present disclosure are applicable to various networks (e.g., a Bluetooth network, a Li-Fi network, or an ultrasonic network, etc.).

According to one embodiment, if the electronic device 501 uses a server (e.g., the IMS network server 551, the service network server 561, or the Wi-Fi network server 571) to share content (e.g., an image, a text, or a video, etc.) with the second external electronic device 505, the server may provide a service associated with the content. For example, if the electronic device 501 uses a Message Session Relay Protocol (MSRP) or a Real Time Protocol (RTP) to transmit content to the second external electronic device 505 through the IMS network 550, the IMS network server 551 may provide a service associated with the content. For example, based on information associated with content, the server may provide a service associated with the content (e.g., narration information generation, content grouping, sharing, content change, object recognition, or privacy protection, etc.). For instance, through the server, the electronic device 501 may transmit the information associated with the content, together with the content, to at least one of the first external electronic device 503, the second external electronic device 505 or storage device 563. The server may use the information associated with the content, to provide information about content sharing to the first external electronic device 503. Additionally or alternatively, the server may modify the content, based on information (e.g., a content request) corresponding to the first external electronic device 503.

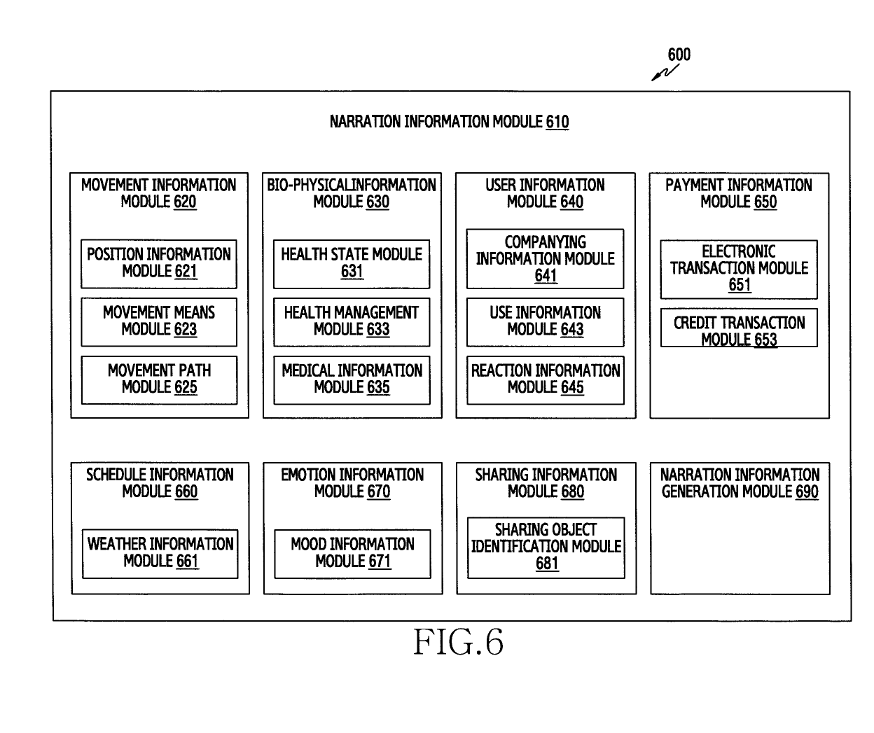

FIG. 6 illustrates a block diagram 600 of an example of a narration information module 610, according to an embodiment of the present disclosure.

According to one embodiment, the narration information module 610 may generate narration information corresponding to content, and provide the narration together with the content. According to one embodiment, the narration information module 610 may include at least one of a movement information module 620, a biophysical information module 630, a user information module 640, a payment information module 650, a schedule information module 660, an emotion information module 670, a sharing information module 680, or a narration information generation module 690. According to one embodiment, the narration information module 610 may include one or more processors and/or one or more processor-executable instructions that are executed by the one or more processors. According to one embodiment, at least a part of the narration information module 610 may include at least one external device (e.g., the content service server module 486).

According to one embodiment, the movement information module 620 may use at least one of a position information module 621, a movement means module 623, or a movement path module 625, to identify movement information. For example, the position information module 621 may identify position information corresponding to content. For instance, the position information module 621 may identify the position information corresponding to the content, based on information received from an external device such as a GPS, a Wi-Fi Positioning System (WPS), or a base station, etc. Or, the position information module 621 may identify position information corresponding to content, based on information received from an external device (e.g., a location-based service device, etc.). For instance, the position information module 621 may use information received from a wireless device associated with an airport or a wireless device associated with a car, to identify position information corresponding to content as the airport or the car. Or, the position information module 621 may identify position information corresponding to content, through recognition of an object (e.g., a building or a signboard, etc.) included in the content. For instance, if the object included in content is the Eiffel tower, the position information module 621 may identify France, Paris, or the Eiffel tower, etc. as the position information corresponding to the content. Thus according to aspects of the disclosure, the position information corresponding to the content may include an indication of a location where the content is generated.

According to one embodiment, if an electronic device moves from a first position to a second position, the movement means module 623 may generate an indication of a movement means associated with the electronic device. The indication of the movement means may identify, among other things, a type of transportation that is used to move the electronic device. As used throughout the disclosure, the phrase “type of transportation” may refer to one or more of a type of vehicle that is used to move the electronic device, a transit line that is used to move the electronic device (e.g., a bus line), and/or a transportation modality that is used to move the electronic device (e.g., air travel, underground travel, on-foot travel, etc.). For example, if position information of the electronic device includes a position corresponding to an airport, and the electronic device moves at a designated speed or more or moves at a designated height or more, the movement means module 623 may identify an airplane as a movement means. For instance, the movement means module 623 may acquire information associated with the movements of the electronic device, such as a movement speed of the electronic device or a height thereof, through a sensor. Or, the movement means module 623 may acquire flight information corresponding to the electronic device, through an electronic ticket (e-ticket) application, schedule information, or a server. For instance, the movement means module 623 may identify the airplane as the movement means, based on at least one of the flight information, sensor information, the schedule information or position information.

According to one embodiment, if an electronic device moves in a designated pattern (e.g., stopping, etc. at a designated speed or more in a designated position during a designated time) along a designated path (e.g., a car only road), the movement means module 623 may identify a car as a movement means. Or, if the electronic device moves along the car only road while moving in a designated pattern (e.g., starting after stopping for a while, etc.) in a designated position (e.g., a bus stop), the movement means module 623 may identify a bus as a movement means. Or, if the electronic device moves along multiple designated positions (e.g., stops of a bus line), the movement means module 623 may identify a bus of a designated number as a movement means. According to one embodiment, if the electronic device moves along a bicycle only road in a designated pattern (e.g., at a designated speed), the movement means module 623 may identify a bicycle as a movement means.

According to one embodiment, if the electronic device connects to a designated communications network, the movement means module 623 may identify a designated movement means (e.g., a subway). According to one embodiment, the movement means module 623 may use information acquired by using a sensor, to determine whether a user walks or runs. For example, the movement means module 623 may identify walking or running, as a movement means. Or, if the user is moving despite the fact that the user does not walk or run, the movement means module 623 may determine that the user is moving by at least one movement means.

According to one embodiment, the movement path module 625 may identify a movement path of an electronic device. For example, the movement path module 625 may identify a movement path (e.g., a travel path) of an electronic device from a first position to a second position, and identify arrival place information, destination information, or path place information. For instance, the movement path module 625 may acquire the destination information based on a change (e.g., a staying time, etc.) of position information of the electronic device. For example, the movement path module 625 may generate movement path information (e.g., travel path information) indicating that the electronic device has moved to Paris, based on a change of position information of the electronic device from Seoul to Paris.

According to one embodiment, the movement path module 625 may use a movement path of the electronic device, to identify information about different locations of a user of the electronic device. For example, the movement path module 625 may identify an area where the user is located in accordance with a time pattern (e.g., during the night hours) as a residence of the user. Or, the movement path module 625 may determine an area where the user is located in accordance with another time pattern (e.g., during the weekdays or during the daylight hours) as a workplace of the user. According to one embodiment, the movement path module 625 may identify an area where the user is located in accordance with yet another time pattern (e.g., during the weekends for no more than two hours) as a major location (e.g., a residence of a relative of the user (e.g., a parent). For example, if information (e.g., a photo, a radio signal, a voice, or a user input, etc.) corresponding to a particular person (e.g., a parent) is acquired in an area staying on a weekend periodically, the movement path module 625 may identify the location of the area as one that is associated with the particular person. Or, the movement path module 625 may obtain information about a location (e.g., home address) corresponding to the particular person through a server (e.g., an SNS server, etc.), and identify a corresponding area.

According to one embodiment, the movement path module 625 may identify an area staying in a designated pattern (e.g., a newly or occasionally visiting, long distant area). For example, the movement path module 625 may identify trip information (e.g., a trip place or a picnic place, etc.) based on a movement path. For example, the movement path module 625 may identify additional information associated with the trip (e.g., a name of a building, a name of a noted place, or a name of a restaurant, etc.) through an external device (e.g., the electronic device 403 and 405 or the server 480, etc.).

According to one embodiment, the biophysical information module 630 may use at least one of a health state module 631, a health care module 633, or a medical information module 635, to identify biophysical information. For example, the biophysical information may include at least one of blood pressure information, heart rate information, blood sugar information, oxygen saturation information, electrocardiogram information, biorhythm, body mass index, hip-to-waist ratio information, muscle mass information, body smell information, basal metabolic mass information, or momentum information. Or, the biophysical information may include at least one of a biophysical information change history, a health target, a health state, an exercise target, prescription information, medical examination information, or dosage information. Or, the biophysical information may include information (e.g., Uniform Resource Locator (URL) or authorization information) accessible to a health examination result.

According to one embodiment, the health state module 631 may use information acquired through a biophysical sensor operatively connected to an electronic device, to identify a health state of a user. For example, the health state module 631 may identify a blood sugar state of the user through a blood sugar sensor. According to one embodiment, the health care module 633 may identify a health target of the user. For example, the health care module 633 may set a health target, based on information about the health state of the user. Or, the health care module 633 may store a health target of the user, and compare the health target and a health state. Or, the health care module 633 may identify information capable of promoting a health of the user. For instance, the health care module 633 may search health care information (e.g., a gymnasium, a clinic, a jogging path, a trail, an exercise club, or a massage, etc.) recommendable to the user.

According to one embodiment, the health care module 633 may use multiple contents, to identify a health state of a user. For example, the health care module 633 may use multiple contents (e.g., photos) corresponding to the user, to identify information about a weight of the user, a skin color, a body form, or a posture, etc. For instance, the health care module 633 may compare an image of the user that is captured at a first time point and an image of the user that is captured at a second time point, and identify information about a weight change of the user, a health change, a body form change, a gait change, a growth state, a backbone state change, or a posture change, etc. According to one embodiment, the health care module 633 may set at least one comparison target, to identify a change of the user. For example, the health care module 633 may set a comparison object in one or more contents, and identify the change of the user through comparison between the comparison object and the user. For instance, the health care module 633 may set indoor furniture (e.g., a table or a desk, etc.) as the comparison object, and compare the sizes of the indoor furniture and the user, and identify the weight change of the user, the body form change, or the growth state, etc. According to one embodiment, the comparison object may include at least one user.

According to one embodiment, the health care module 633 may use at least one image, to analyze a look of a user, a gait, or a posture, etc., and identify an emotion state (e.g., a melancholia, or a stress degree, etc.) of the user. According to one embodiment, the medical information module 635 may identify medical information of the user. For example, the medical information module 635 may use at least one of the medical information of the user, prescription information, dosage information, or health examination information, to identify the medical information of the user.

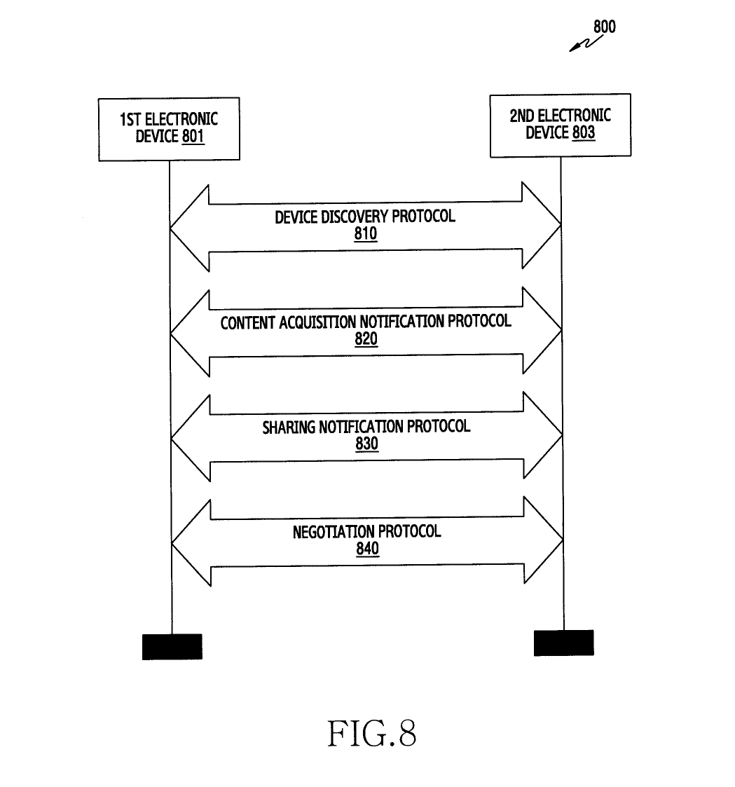

According to one embodiment, the user information module 640 may use at least one of an accompanying information module 641, a use information module 643, or a reaction information module 645, to identify information associated with a user. For example, the accompanying information module 641 may identify information about another user who is present at a time or location at which a first user acquires content with his or her electronic device. Thus, the accompanying user may be one who accompanying the author of content when the content is created. For instance, the accompanying information module 641 may use information acquired through at least one of a device discovery protocol 801 or a content acquisition notification protocol 820 of FIG. 8, to identify the accompanying user. Or, the companying information module 641 may recognize information (e.g., a face or voice, etc.) corresponding to an accompanying user included in content, and identify the companying user. According to one embodiment, the accompanying information module 641 may acquire information (e.g., movement information, biophysical information, user information, schedule information, or emotion information, etc.) about the accompanying user, from an electronic device corresponding to the companying user.

According to one embodiment, the use information module 643 may identify a use state of an electronic device. More particularly, the use information module 643 may obtain use information identifying the manner in which a user uses an electronic device. For example, the use information may include at least one of a grip state, a wearing state, use or non-use, external device connection, frequency, use time, or movement state. According to one embodiment, the use information module 643 may include various sensors such as a grip sensor or a motion sensor.

According to one embodiment, the reaction information module 645 may identify user's reaction information about content. For example, the reaction information may include at least one of a voice reaction, a linguistic reaction, a look reaction, a biophysical information reaction, or a gesture reaction. For instance, the reaction information module 645 may identify reaction information about content through a server (e.g., an SNS server). Or, the reaction information module 645 may identify reaction information about content, through an input device operatively connected to the electronic device.

According to one embodiment, the payment information module 650 may include at least one of an electronic transaction module 651 or a credit transaction module 653. For example, the payment information module 650 may identify payment information associated with an electronic device. According to one embodiment, the electronic transaction module 651 may use the electronic device, to identify electronic transaction information. For instance, the electronic transaction information may include payment information through a payment application such as Samsung wallet. According to one embodiment, the credit transaction module 653 may use a credit card, to identify credit transaction information. For example, the credit transaction module 653 may use the credit card, to identify payment notification information about a transaction. For instance, the payment notification information may include at least one of a sum involved, time of the transaction, or a location of the transaction.

According to one embodiment, the schedule information module 660 may include a weather information module 661. For example, the schedule information module 660 may use schedule information of one or more users (e.g., the respective calendars of the users), to identify schedule information associated with content. For instance, the schedule information module 660 may use schedule information of a first user (e.g., a user of an electronic device) and a second user (e.g., a user of an external device), to identify various types of schedule information such as an event name, an event location, or an event participant, etc. associated with content. According to one embodiment, the weather information module 661 may identify the weather a time and/or location corresponding to a schedule or content. For example, the weather information module 661 may identify the weather at a time or position stored in metadata of content (e.g., an image), based on the corresponding time or position.

According to one embodiment, the emotion information module 670 may include a mood information module 671. For example, the emotion information module 670 may recognize at least a part of content, and identify emotion information of one or more users. In some implementations, the emotion information may identify a type of emotion which the content invokes in the one or more users. For instance, the emotion information module 670 may recognize first information (e.g., a look of a first user, a gesture, or a voice, etc.) and second information (e.g., a look of a second user, a gesture, or a voice, etc.) corresponding respectively to the first user (e.g., a user of the electronic device) and the second user (e.g., a user of the external device), and identify emotion information of the first user and the second user. Or, the emotion information module 670 may use information (e.g., heart rate information, hormone change, or pupil dilation, etc.) identified through a biophysical sensor, to identify emotion information. According to one embodiment, the emotion information module 670 may include at least a part of the reaction information module 645.

According to one embodiment, the mood information module 671 may recognize at least a part of content, and identify mood information corresponding to the content. For example, the mood information module 671 may include a device such as the recognition module 423. For instance, the mood information module 671 may analyze content (e.g., an image), and identify mood information of the content. For instance, if the content includes an image of a party place, the mood information module 671 may identify mood information “interesting” or “enthusiastic”. For instance, if the content includes a hymn played on a pipe organ, the mood information module 671 may identify mood information “pious” or “divine”. For instance, if the content includes an image corresponding to a dark restaurant, the mood information module 671 may identify mood information “classical” or “romantic”. According to one embodiment, the mood information module 671 may use the position information module 621, to identify mood information. For example, if position information corresponding to content is a performance place, the mood information module 671 may identify mood information “interesting” or “enthusiastic”.

According to one embodiment, the sharing information module 680 may include a sharing object identification module 681. For example, the sharing information module 680 may identify sharing information that identifies one or more characteristics of transactions in which content was transmitted to an external device or received from the external device. For example, the sharing information may include at least one of a time at which an electronic device shares content, a user, a count, or a user's reaction. The sharing information module 680 may acquire the sharing information at a time point of sharing, or may acquire the sharing information after sharing. According to one embodiment, the sharing information module 680 may identify sharing history information about content. According to one embodiment, the sharing information module 680 may identify information that content is shared, as the sharing information.

According to one embodiment, the sharing object identification module 681 may identify the external device or a user of the external device. For example, if the user of the external device corresponds to a first group (e.g., a friend), the sharing object identification module 681 may decide a narration information type of a first attribute (e.g., emoticon use) corresponding to the first group. Or, if the user of the external device corresponds to a second group (e.g., a workplace fellow), the sharing object identification module 681 may decide a narration information type of a second attribute (e.g., a courteous language). According to one embodiment, the sharing object identification module 681 may decide the narration information type, based on a type of an external device transmitting content. According to one embodiment, the sharing object identification module 681 may decide whether or not to provide narration information, based on a content sharing object.

According to one embodiment, the narration information generation module 690 may use at least one of the movement information module 620, the biophysical information module 630, the user information module 640, the payment information module 650, the schedule information module 660, the emotion information module 670, or the sharing information module 680, to generate narration information. For example, the narration information generation module 690 may generate narration information corresponding to one or more contents. According to one embodiment, the narration information generation module 690 may group one or more contents corresponding to a designated condition. For example, the narration information generation module 690 may use various types of information regarding the one or more contents, such as the location(s) where the contents were generated, the time(s) when the contents were created, whether the one or more contents were shared and/or changed, as a basis for identifying one or more groups (e.g., by schedule, a first day of trip, a second day of trip, a first position, or a second position, etc.). According to one embodiment, the narration information generation module 690 may provide narration information by each content or each group. For example, the one or more contents may include contents corresponding to multiple electronic devices.

According to one embodiment, the narration information generation module 690 may use at least one of the movement information module 620, the biophysical information module 630, the user information module 640, or the schedule information module 660, to generate narration information. For example, the narration information generation module 690 may provide narration information “5/9 11:20, Hiking in the Mt. Halla with Mike and Tom. Tom and I need to work out more. 1252 m above sea level. 78 avg. bpm”. For instance, the narration information generation module 690 may generate narration information “Hiking in the Mt. Halla with Mike and Tom.” based on at least one of movement information, schedule information or user information. Or, the narration information generation module 690 may generate narration information related to the health of one or more users, such as “Tom and I need to work out more. 78 avg. bpm.”, based on biophysical information. For instance, the narration information generation module 690 may compare biophysical information corresponding to Mike, Tom, and I, and use the outcome of the comparison as a basis for generating the narration information. Or, the narration information generation module 690 may compare designated biophysical information (e.g., a healthy person standard or a health target, etc.) and the biophysical information corresponding to Mike, Tom, and I, to generate narration information. Or, the narration information generation module 690 may generate narration information “5/9 11:20, 1252 m above sea level” based on position information, time information, or sensor information (e.g., a height sensor, etc.).

According to one embodiment, the narration information generation module 690 may use the movement information module 620 or the schedule information module 660, to generate narration information “On the flight to Paris, 6000 ft on the sea level”. For example, the narration information generation module 690 may use schedule information (e.g., a movement plan, an itinerary, a calendar, etc.), to generate narration information “On the flight to Paris”. Or, the narration information generation module 690 may use movement information (e.g., movement means information, movement path information, etc.) and a time (e.g., a photographing time or an update time, etc.) of content, to generate narration information “On the flight to Paris”. According to one embodiment, the narration information generation module 690 may use the movement path information and the time of content, to generate narration information “6000 ft on the sea level”.

According to one embodiment, the narration information generation module 690 may use the biophysical information module 630, to generate narration information. For example, the narration information generation module 690 may generate narration information “Physical strength is getting better”, “Blood sugar level is getting worse. Care is needed, “It has only to decrease a kilogram weight only!”, “2 inches to a target”, or “muscle mass is increasing”, based on biophysical information. Or, the narration information generation module 690 may compare information (e.g., biophysical information) associated with a user of an electronic device or information (e.g., biophysical information) associated with a user of an external device, to generate narration information including the comparison information. For example, the narration information generation module 690 may generate narration information “Tom's health state is getting better”, “Let's try with me, too”, “Tom's muscle mass gets better than mine by 10%”, “Tom's body mass index (BMI) gets better than John's”, or “Kim's electrocardiogram is not good. Let's exercise often together”.

According to one embodiment, the narration information generation module 690 may use the health care module 633, to generate narration information. For example, the narration information generation module 690 may use information about a weight change of a user, a health change, a body line change, a gait change, a growth state, a backbone state change, or a posture change, etc., to generate narration information including generated health information. For instance, the narration information generation module 690 may generate narration information “Kim's posture needs a little work”. Or, the narration information generation module 690 may generate narration information “Jane, sorry for telling this. You seem to be gaining weight”, “Maybe you should exercise more”. Or, the narration information generation module 690 may generate narration information “MJ's son is very tall. You seem short by comparison”, or “MJ's son is very tall. Now, he is taller than the table”.

According to one embodiment, the narration information generation module 690 may use the health care module 633, to generate narration information related to a mental health of a user. For example, the narration information generation module 690 may generate narration information including information about a mental health state of the user, generated using the mental health state decided by analyzing one or more contents (e.g., analyzing an image at a first time point and a second time point). For instance, the narration information generation module 690 may generate narration information “Lee does not look very good recently. Lee seems gloomy. Console him” Or, the narration information generation module 690 may generate narration information “My honorable master, you did not laugh even one time today. Do you have any difficulty?”.

According to one embodiment, the narration information generation module 690 may use at least one of the position information module 621 or the payment information module 650, to generate narration information. For example, the narration information generation module 690 may generate narration information “at Jin's restaurant”, based on payment information. For instance, the narration information generation module 690 may generate narration information “at Jin's restaurant”, based on at least one of the current location of the device, current time, or payment information regarding an executed transaction. Additionally, the narration information generation module 690 may use the emotion information module 670, to generate narration information “romantic dinner, at Jin's restaurant”.

According to one embodiment, the narration information generation module 690 may use the sharing information module 680, to generate narration information. For example, the narration information generation module 690 may generate narration information about content, based on sharing information. For instance, the narration information generation module 690 may generate narration information such as “Shared with John and Kim. Also, posted in SNS, Linked by Kim” According to one embodiment, the narration information generation module 690 may use content acquired in multiple electronic devices, to provide narration information. For example, if a first content acquired in a first electronic device and a second content acquired in a second electronic device have a matching characteristic (e.g., if the first content are generated at approximately the same time or location), the narration information generation module 690 may use the first content and the second content, to identify one or more groups. For instance, the narration information generation module 690 may use information identified through the companying information module 641, to group, as one or more groups, the first content and second content that the first electronic device and second electronic device each acquire while companying, and provide narration information corresponding to the grouped contents. Or, the narration information generation module 690 may analyze the first content and the second content and, if the first content represent the same of similar subject matter (e.g., if the first and second content include an image of a first user or a first location), the narration information generation module 690 may group the first content and the second content as one or more groups, and provide narration information corresponding to the grouped contents. Or, if the first content and the second content include information about each other, the narration information generation module 690 may group the first content and the second content as one or more groups, and provide narration information corresponding to the grouped contents.

An electronic device according to various embodiments of the present disclosure may include a communication module (e.g., the communication module 220) for communicating with an external device located outside of the electronic device, and a content service module (e.g., the content service module 420). For example, the content service module may acquire one or more contents through a sensor module (e.g., the sensor module 413) operatively connected with the electronic device, and use the communication module to transmit notification information corresponding to the one or more contents, to an external device, and receive a response corresponding to the notification information from the external device, and change the one or more contents based on the response.

The communication module according to various embodiments of the present disclosure may transmit notification information to an external device, by directive wireless communication. According to various embodiments of the present disclosure, the communication module may transmit the notification information, in a direction corresponding to a direction in which the sensor module acquires one or more contents.

The content service module according to various embodiments of the present disclosure may be set to transmit notification information to an external device, through at least one communications network, at least one server, short-range wireless communication, or directive wireless communication. The notification information according to one embodiment may include at least one of a position, a direction, a time, or identification information associated with the electronic device or the sensor module.

The content service module according to various embodiments of the present disclosure may receive at least one of a position of an external device, a time, identification information from the external device, and determine if one or more contents include information associated with the external device based on the at least one, and transmit notification information to the external device if the one or more contents include the information associated with the external device.

The content service module according to various embodiments of the present disclosure may identify other content associated with one or more contents based on a response, and present at least a part of the other content and link information about this in association with the one or more contents. For example, the response may include the other content or information (e.g., a position of the other content or identification information thereof, etc.) about the other content.

The content service module according to various embodiments of the present disclosure may identify an audio acquired from the external device based on the response, and use the acquired audio to change at least a part of an audio included in the one or more contents.

The content service module according to various embodiments of the present disclosure may include, in the notification information, information requesting an external device to acquire at least one of an audio, a video, or an image during a time of a designated duration.

The content service module according to various embodiments of the present disclosure may transmit the notification information to the external device, before acquiring the one or more contents.

The content service module according to various embodiments of the present disclosure may include, in the notification information, information requesting the external device to recognize at least one object included in the one or more contents.

The content service module according to various embodiments of the present disclosure may acquire at least one information among identification information about an external device or feature information about a user of the external device, based on the response, and recognize at least one object corresponding to the external device or the user of the external device in the one or more contents, based on the at least one information.

The content service module according to various embodiments of the present disclosure may delete or change one portion corresponding to the user of the external device in the one or more contents.

The content service module according to various embodiments of the present disclosure may determine if the one or more contents include information corresponding to the external device or at least one object corresponding to the user of the external device, and execute the change based on the response only if the one or more contents include the at least one object.

The content service module according to various embodiments of the present disclosure may include the operation of, based on the response, generating narration information corresponding to the one or more contents associated with the external device, and providing the one or more contents in association with the narration information. The content service module according to various embodiments of the present disclosure may provide movement information about at least one of the electronic device or the external device, as at least a part of the narration information.

The content service module according to various embodiments of the present disclosure may identify a sharing request for the one or more contents based on the response, and share at least a part of the one or more contents with the external device if the one or more contents include information corresponding to the external device.

The content service module according to various embodiments of the present disclosure may identify reaction information of a user of the external device about the one or more contents, based on the response, and change the one or more contents based on the reaction information.

The content service module according to various embodiments of the present disclosure may identify first reaction information of a first user and second reaction information of a second user about the one or more contents, and change a first area corresponding to the first user or the first reaction information in the one or more contents, based on the first reaction information, and change a second area corresponding to the second user or the second reaction information in the one or more contents, based on the second reaction information.

The content service module according to various embodiments of the present disclosure may decide to share the one or more contents with other external devices, and transmit the notification information to the external device such that the notification information includes information associated with the sharing.

The content service module according to various embodiments of the present disclosure may identify a first request to the external device for the one or more contents, based on the response, and transmit negotiation information corresponding to the first request to the external device, and receive an additional response to the negotiation information from the external device, and identify a second request for the one or more contents in the additional response, and change the one or more contents based on the second request.

An electronic device according to various embodiments of the present disclosure may include a storage module (e.g., the memory 230) for storing one or more contents, and a narration information module (e.g., the description information module 426). The narration information module may acquire first information corresponding to at least one of an external device for the electronic device or a user of the external device, generate narration information corresponding to the one or more contents such that the narration information includes second information associated with the at least one of the external device or the user of the external device, generated based on at least a part of the first information, and provide the one or more contents in association with the narration information. The first information according to one embodiment may include at least one of position information corresponding to the external device, address information, account information, or identification information.

The narration information module according to various embodiments of the present disclosure may use a biophysical sensor operatively connected to the electronic device, to identify biophysical information corresponding to a user of the electronic device, and provide the narration information such that the narration information includes third information related to the health of the user of the electronic device, generated using the biophysical information.

The narration information module according to various embodiments of the present disclosure may acquire third information corresponding to at least one of the electronic device or a user of the electronic device, and generate the narration information including the second information, such that the second information includes fourth information generated by comparing one portion of at least the first information and a corresponding portion of the third information with each other.

The narration information module according to various embodiments of the present disclosure may identify a movement path related with the movements of the external device from a first position to a second position, from the first information, and generate the narration information including the second information, such that the second information includes third information generated based on at least one of the first position, the second position, and the movement path.

The narration information module according to various embodiments of the present disclosure may identify a movement means related with the movement of the external device, from the first information, and generate the narration information including the second information, such that the second information includes at least one of a text, an image, or a video generated based on the movement means.

The narration information module according to various embodiments of the present disclosure may generate third information associated with an emotion or mood corresponding to the one or more contents, based on the first information or the one or more contents, and generate the narration information such that the narration information includes the third information.

The narration information module according to various embodiments of the present disclosure may identify reaction information about the one or more contents acquired from the user of the external device, from the first information, and generate the narration information including the second information, such that the second information includes the reaction information.

The narration information module according to various embodiments of the present disclosure may identify other narration information corresponding to the one or more contents generated in the external device, and generate the narration information including the second information, such that the second information includes third information generated using at least a part of the other narration information.

The narration information module according to various embodiments of the present disclosure may identify third information about the electronic device or a user of the electronic device, compare the first information and the third information, and generate first comparison information associated with both the first information and the third information, or second comparison information associated with only one of the first information or the third information, and generate the narration information including the second information, such that the second information includes at least one of the first comparison information or the second comparison information.

The narration information module according to various embodiments of the present disclosure may use a directive communication module operatively connected to the electronic device, to transmit a request associated with the first information to the external device located in a position associated with the one or more contents.

The narration information module according to various embodiments of the present disclosure may compare first position information corresponding to the at least one, acquired using the first information and second position information corresponding to the one or more contents, and provide the narration information such that, if a position indicated by the first position information and a position indicated by the second position information are within a predetermined distance from one another, the narration information includes the second information.

The narration information module according to various embodiments of the present disclosure may use the first information, to identify type information or use state information of the external device, and by using the type information or use state information, use position information of the external device as position information of the user of the external device, to generate the second information.

The narration information module according to various embodiments of the present disclosure may insert, substitute, or connect other content to at least a part of the one or more contents, and provide the narration information such that the narration information includes third information generated in relation with the other content. The one or more contents according to one embodiment may include first content acquired by the electronic device or second content acquired by the external device.

The narration information module according to various embodiments of the present disclosure may recognize at least one object among a plurality of objects included in the one or more contents, determine at least one position information corresponding to the one or more contents, based on the at least one object, and provide the narration information such that the narration information includes third information generated using the at least one position information.

The narration information module according to various embodiments of the present disclosure may identify first movement information corresponding to the electronic device and second movement information corresponding to the external device, generate first comparison information associated with both the first movement information and the second movement information, or second comparison information associated with only one of the first movement information or the second movement information, and provide the narration information such that the narration information includes at least one of the first comparison information or the second comparison information.

The narration information according to various embodiments of the present disclosure may include first narration information corresponding to a first external device or second narration information corresponding to a second external device. The narration information module according to one embodiment of the present disclosure may transmit the first narration information to the first external device, and transmit the second narration information to the second external device.

An electronic device according to various embodiments of the present disclosure may include a communication module (e.g., the communication module 220) for communicating with an external device located outside the electronic device, and a content service module (e.g., the content service module 420 or the content service server module 486). For example, the content service module may acquire one or more contents through a sensor module operatively connected to the electronic device, and provide a service associated with the one or more contents in association with the external device if the one or more contents include information corresponding to the external device or at least one object corresponding to a user of the external device.

An electronic device according to various embodiments of the present disclosure may include a storage module (e.g., the memory 230) for communicating with an external device located outside the electronic device, and a content service module (e.g., the content service module 420 or the content service server module 486). For example, the content service module may acquire reaction information associated with the one or more contents, and change at least a part of content based on the reaction information.

An electronic device according to various embodiments of the present disclosure may include a storage module (e.g., the memory 230) for communicating with an external device located outside the electronic device, and a content service module (e.g., the content service module 420 or the content service server module 486). For example, the content service module may analyze the one or more contents, and determine a health state of a user of the electronic device, and provide narration information corresponding to the health state to the user.

An electronic device according to various embodiments of the present disclosure may include a storage module (e.g., the memory 230) for communicating with an external device located outside the electronic device, and a content service module (e.g., the content service module 420 or the content service server module 486). For example, the content service module may identify at least one of a first content and first position information or first direction information of the first content, as first information, and identify at least one of a second content and second position information or second direction information of the second content, as second information, and use the first information and the second information, to synthesize at least a part of the first content and at least a part of the second content.

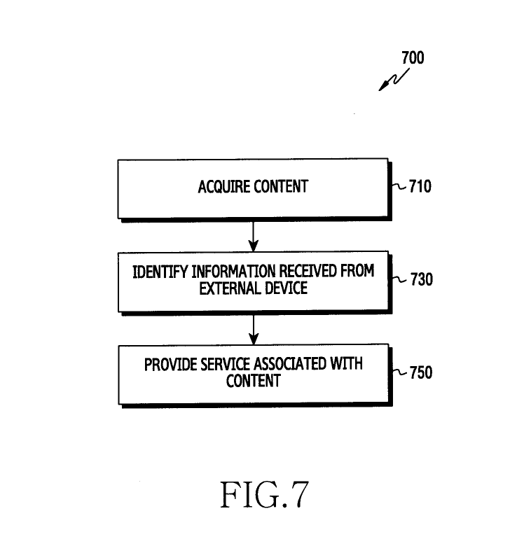

FIG. 7 is a flowchart of an example of a process 700, according to an embodiment of the present disclosure.

According to one embodiment, in operation 710, the electronic device (e.g., the content service module 420) may acquire one or more contents. For instance, the electronic device may acquire content (e.g., an image, a video, a text, or an audio, etc.) through a sensor module (e.g., the sensor module 413) operatively connected to the electronic device. Or, the electronic device may receive an input of content (e.g., a text or handwriting, etc.) from a user through a user interface operatively connected to the electronic device. Or, the electronic device may receive content from an external device. Or, the electronic device may generate content (e.g., a call history or a text history, etc.).

According to one embodiment, in operation 730, the electronic device may receive information from an external device (e.g., the first external electronic device 403 or the second external electronic device 405). For example, the electronic device may receive a signal (e.g., a discovery signal or a beacon signal, etc.) including identification information of the external device. Or, the electronic device may receive from the external device at least one request (e.g., change, deletion, or sharing, etc.) for the content. Or, the electronic device may identify information (e.g., additional content or narration information, etc.) associated with the content received from the external device, in association with the content. In some instances, the electronic device may the information may be embedded in the content as metadata and the electronic device may receive both the one or more contents and the information from the external device.

According to one embodiment, in operation 750, the electronic device may use the received information, to provide a service associated with the content. For example, the electronic device may recognize object information or additional information corresponding to at least one object included in the content. Or, the electronic device may modify (e.g., delete, substitute, or synthesize, etc.) at least a part of the content, based on the information received from the external device. Or, the electronic device may share at least a part (e.g., content including information corresponding to the external device) of the content with the external device. Or, the electronic device may generate narration information corresponding to the content, based on the information received from the external device.

FIG. 8 is a diagram of an example of a protocol stack 800, according to an embodiment of the present disclosure. By way of example, the protocol stack 800 may be used to facilitate communications between a first electronic device 801 and a second electronic device 803.

Referring to FIG. 8, for example, the protocol stack 800 may include at least one of a device discovery protocol 810, a content acquisition notification protocol 820, a sharing notification protocol 830, or a negotiation protocol 840.

According to one embodiment, the device discovery protocol 810 may include a protocol that permits a given electronic device to detect an external electronic device capable of communicating with the given electronic device. For example, a first electronic device 801 (e.g., the electronic device 401) may sense the second electronic device 803 (e.g., the electronic device 403 or 405) as a device capable of using the device discovery protocol 810 to communicate with the first electronic device 801 through a communication method (e.g., Wi-Fi, BT, LTE direct, WiGig, or USB, etc.) available in the first electronic device 801. The first electronic device 801 may use the device discovery protocol 810, to acquire and store identification information (e.g., Media Access Control (MAC) address, Universally Unique Identifier (UUID), SubSystem Identification (SSID), Internet Protocol (IP) address, or web server account information) about the sensed second electronic device 803. For example, the first electronic device 801 may provide a service related to content, based on at least identification information.

According to one embodiment, the device discovery protocol 810 may, for example, use directive communication. For example, the first electronic device 801 may include at least one of a directive microphone module, a beamforming antenna, a Li-Fi module, an infrared communication module, or an ultrasonic communication module. For instance, the electronic device 801 may transmit/receive a directive communication signal in a photographing direction (e.g., toward a front surface or rear surface of the electronic device) of a camera module (e.g., the camera module 291). For instance, the device discovery protocol 810 may sense an external device located in a direction associated with content, through the directive communication. Or, the device discovery protocol 810 may transmit information corresponding to the first electronic device 801, to the external device located in the direction associated with the content, through the directive communication. According to one embodiment, the first electronic device 801 may store (e.g., metadata or additional database) information (e.g., identification information or a position, etc.) about the external device located in the direction associated with the content, in association with the content.

According to one embodiment, the device discovery protocol 810 may sense an external device located in a direction associated with content, based on position information of the external device. For example, the first electronic device 801 may receive the position information of the external device from the external device (e.g., the second electronic device 803) or a server (e.g., the server 480). The first electronic device 801 may determine the external device located in the position associated with the content, based on the position information of the external device and position information of a sensor module operatively connected to the first electronic device 801. For instance, the first electronic device 801 may compare a position of the sensor module and the position information of the external device, thereby determining the external device located in the position associated with the content. Additionally, the first electronic device 801 may use direction information of the sensor module, to sense the external device located in the direction associated with the content. For instance, if the first electronic device 801 uses the sensor module to photograph an image in the East of the sensor module, the first electronic device 801 may determine an external device whose position information corresponds to the East of the sensor module, as the external device located in the direction associated with the content.

According to one embodiment, the content acquisition notification protocol 820 may include a protocol for providing information related to content acquisition to an external device (e.g., the second electronic device 803) if an electronic device (e.g., the first electronic device 801) acquires or decides to acquire content. For example, if the first electronic device 801 acquires content (e.g., an image or a video) through the sensor module, the first electronic device 801 may transmit information associated with the acquired content, to the second electronic device 803. For instance, the information associated with the content may include at least one of a position, a direction, a time, a viewing angle, or identification information associated with at least one of the first electronic device 801 or the sensor module. Or, the information associated with the content may include at least a part of the content or content (i.e., compression or resolution decrease, etc.) of a low capacity.

According to one embodiment, the second electronic device 803 may use the content acquisition notification protocol 820, to determine if content acquired by the first electronic device 801 includes information about the second electronic device 803. For example, the second electronic device 803 may compare information (e.g., a position or a time, etc.) of the second electronic device 803 and information (e.g., a time, a position, or a direction, etc.) associated with content, and determine if the content includes the information about the second electronic device 803, based on whether there is the second electronic device 803 in a position related to the content at a time point the content is acquired. According to one embodiment, if the content includes the information about the second electronic device 803, the second electronic device 803 may transmit a response to the first electronic device 801. For example, the second electronic device 803 may transmit a request (e.g., sharing or private protection, etc.) for the content or additional information (e.g., identification information of the second electronic device 803) to the first electronic device 801.

According to one embodiment, the content acquisition notification protocol 820 may include directive communication. For example, the second electronic device 803 may determine if content acquired by the first electronic device 801 includes information about the second electronic device 803, based on a directive communication method. For instance, if receiving information of the content acquisition notification protocol 820 through the directive communication method, the second electronic device 803 may determine that the content acquired by the first electronic device 801 includes the information about the second electronic device 803. According to one embodiment, the content acquisition notification protocol 820 may include a recognition request corresponding to [Table 1] above. For example, the first electronic device 801 may recognize object information or additional information about an object included in content, through the content acquisition notification protocol 820.

According to one embodiment, if a designated condition is satisfied, the first electronic device 801 may transmit information of the content acquisition notification protocol 820 to the second electronic device 803. For example, the first electronic device 801 may transmit the information of the content acquisition notification protocol 820, to an external device (e.g., the second electronic device 803) associated with content sensed through the device discovery protocol 810. For instance, if it is determined that the content includes the information about the second electronic device 803 based on position information about the second electronic device 803, the first electronic device 801 may transmit the information of the content acquisition notification protocol 820 to the second electronic device 803. Or, the first electronic device 801 may analyze the content and, if the content includes an object corresponding to the second electronic device 803, the first electronic device 801 may transmit the information of the content acquisition notification protocol 820 to the second electronic device 803.

According to one embodiment, the sharing notification protocol 830 may include a protocol for providing information related to content sharing to the second electronic device 803 if the first electronic device 801 shares or decides to share content with an external device (e.g., the server, etc.). For example, if sharing the content with at least one external device, the first electronic device 801 may transmit a sharing notification to an external device associated with the content. For example, the first electronic device 801 may determine the external device associated with the content, through at least one of the device discovery protocol 801 or the content acquisition notification protocol 820. For instance, if the content includes information about the second electronic device 803, the first electronic device 801 may transmit sharing notification information about the content to the second electronic device 803. According to one embodiment, the second electronic device 803 may transmit a content request (e.g., a change of at least a part of the content, or deletion, etc.) to the first electronic device 801.

According to one embodiment, the negotiation protocol 840 may include a protocol for the first electronic device 801 to request the second electronic device 803 for content negotiation. For example, the first electronic device 801 may receive a content request from the second electronic device 803, through at least one of the content acquisition notification protocol 820 or the sharing notification protocol 830. The first electronic device 801 may provide at least one service (e.g., a change of at least a part of content, or sharing, etc.) associated with the content, based on the content request of the second electronic device 803. Or, the first electronic device 801 may transmit negotiation information for negotiating the content request of the second electronic device 803, to the second electronic device 803. For example, the first electronic device 801 may transmit negotiation information for modifying a deletion request for deleting only a part of the content, to the second electronic device 803, in response to a content deletion request of the second electronic device 803.

According to one embodiment, the first electronic device 801 may use the entire content request of the second electronic device 803, to provide at least one service associated with the content. Or, the first electronic device 801 may use only a part of the content request of the second electronic device 803, to provide at least one service associated with the content. Or, the first electronic device 801 may change at least a part of the content request of the first electronic device 801, and provide at least one service associated with the content. For example, if failing to provide the entire content request of the second electronic device 803, the first electronic device 801 may transmit negotiation information for changing the content request, to the second electronic device 803. In response to the received negotiation information, the second electronic device 803 may transmit the changed request, or accept the negotiation information.

According to one embodiment, the first electronic device 801 may generate narration information about content in negotiations with the second electronic device 803. For example, the first electronic device 801 may generate first narration information about the content, and transmit the first narration information to the second electronic device 803. For instance, the first electronic device 801 may use at least one of the device discovery protocol 810, the content acquisition notification protocol 820, or the sharing notification protocol 830, to determine if the second electronic device 803 is an external device associated with the content. The second electronic device 803 may generate additional or alternative second narration information in the first narration information, and provide the second narration information to the first electronic device 801. For example, based on the received second narration information, the first electronic device 801 may generate third narration information corresponding to the content, and provide the third narration information to a user.

According to one embodiment, at least one of the protocol stack 800 or a combination thereof may include an expression protocol of LTE direct. For example, the second electronic device 803 may transmit privacy protection information through an expression such as “JeongJinhong@NoPhoto”. For example, based on the expression, the first electronic device 801 may change information corresponding to the second electronic device 803 in content. For instance, based on a received expression, the first electronic device 801 may recognize the information corresponding to the second electronic device 803 in the content, through a recognition module (e.g., the recognition module 423). Or, the first electronic device 801 may use at least a part of the server (e.g., the server 480), to recognize information corresponding to the “JeongJinhong@NoPhoto”, and change the information corresponding to the second electronic device 803 in the content. For instance, the server may include a database corresponding to “NoPhoto”, and recognize information (e.g., privacy information or identification information, etc.) corresponding to “Jeongjinhong” in the database. Or, if the first electronic device 801 stores (e.g., stores in metadata) “JeongJinhong@NoPhoto” information in association with the content and transmits the content to the server, the server may change the information corresponding to the second electronic device 803 in the content.

In FIG. 8, the device discovery protocol 810, the content acquisition notification protocol 820, the sharing notification protocol 830, or the negotiation protocol 840 have been described as separate protocols, but each protocol may include at least some of other protocols.

FIG. 9 is a flowchart of an example of a process 900, according to an embodiment of the present disclosure.

According to one embodiment, in operation 901, the electronic device receive information from an external device that is associated with a particular content. For example, the electronic device may receive various types of information such as identification information of the external device, position information thereof, use state information thereof, type information thereof, or information corresponding to a user of the external device, etc.

According to one embodiment, in operation 930, the electronic device may select information which will be used for recognizing an object that is represented in the content. For example, the electronic device (e.g., the recognition module 423) may select the information which will be used to recognize an object, based on at least a part of the information received from the external device. For instance, the electronic device may select at least one object recognition database among multiple object recognition databases based on the information received from the external device. For example, the multiple object recognition databases may include categories. For instance, the categories may include various categories such as locations, species, people, shops, devices, or brands, etc. According to one embodiment, if type information of the external device is a wearable type, the electronic device may select a wearable device category database.

According to one embodiment, in operation 950, the electronic device may recognize object information or additional information corresponding to the object included in the content. For example, the electronic device may preferentially use the selected database or category, to recognize the object. Or, the electronic device may give priority to a result of the selected database rather than results of other databases, to recognize the object. For instance, the electronic device may give a weight to the information recognized by using the selected database, to recognize the object. According to aspects of the disclosure, the content may include an image, video, audio, text, and/or any other suitable type of content. The object thus may include an image object, an audio object, a text object, and/or any other suitable type of object.

According to one embodiment, the electronic device may acquire content representing a particular merchandise (e.g., an image of a pair of shoes), and receive information (e.g., brand information or position information) related to the merchandise from an external device (e.g., wireless communication device or GPS information related to a shop). According to one embodiment, the electronic device may receive information (e.g., a URL or access authority, etc.) for a database related to the merchandise from the external device. The electronic device may use the received information, to select a database (e.g., a brand homepage, or an Internet shopping mall, etc.) which will be used for recognizing the merchandise. According to aspects of the disclosure, recognizing the merchandise may include identifying any suitable type of information about the merchandise, such as a name, a price, warehouse availability, or popularity, etc.

According to one embodiment, the electronic device may acquire content representing one or more people (e.g., an image of one or more people), and receive identification information (e.g., MAC address or outward shape information, etc.) of external devices associated with the one or more people) through wireless communication (e.g., Bluetooth, etc.). The external devices may include any suitable type of device. In one particular implementation, the external devices may include the people's personal smartphones. For example, the electronic device may use the received identification information of the external devices, to recognize information (e.g., a face, etc.) corresponding to the people represented in the contents. For instance, the electronic device may detect at least one face in the content, and may determine whether the detected at least one face corresponds to a first person or a second person. If receiving the identification information from the electronic device of the first person and failing to receive the identification information from the electronic device of the second person, the electronic device may determine that there is a high probability in which the detected at least one face corresponds or will correspond to the first person.

According to one embodiment, the electronic device may identify at least one of type information or use state information about an external device associated with content. For example, the type information may include information about various types such as a wearable, a cellular phone, a tablet, an access point, a car, a TV, an electric bulb, or electric home appliances, etc. For example, the use state information may include information such as during wearing, during movement, in use, or grip state, etc. Based on the type information, the electronic device may select at least one database, to recognize an object represented in content. According to one embodiment, the electronic device may use the type information and the use state information, to recognize the object included in the content. For example, the electronic device may use information of a worn external device, to recognize (e.g., position recognition or face recognition, etc.) a user of the external device in the content.

FIG. 10 is a sequence diagram of an example of a process 1000, according to an embodiment of the present disclosure.

According to one embodiment, in operation 1010, a first electronic device 1001 (e.g., the electronic device 401) may acquire content. According to one embodiment, in operation 1020, the first electronic device 1001 may receive a device discovery signal (e.g., a discovery signal or a beacon, etc.) from a second electronic device 1003 (e.g., the first external electronic device 403). For example, the device discovery signal may include identification information or user information associated with the second electronic device 1003. Or, the device discovery signal may include privacy protection information of the second electronic device 1003. For example, operation 1020 may include the device discovery protocol 810.

According to one embodiment, the privacy protection information may include a request (e.g., an acquisition notification request, a deletion request, a sharing request, or a change request, etc.) of the second electronic device 1003 for content including information corresponding to the second electronic device 1003 or a user of the second electronic device 1003. For example, the privacy protection information may include information (e.g., outward shape information or position information, etc.) capable of identifying the second electronic device 1003 or the user of the second electronic device 1003. According to one embodiment, the privacy protection information may identify a first privacy condition (e.g., a condition which is satisfied by content when the content depicts a person and/or when the content depicts the person with his or her eyes closed, etc.) or a second privacy condition (e.g., a condition that is satisfied by content when the content depicts a rear view of the user and/or the user squinting, etc.). Furthermore, the privacy protection information may include information requesting a first service (e.g., deletion, substitution, sharing prohibition, or modification, etc.) if content satisfies the first privacy condition, or requesting a second service (e.g., storing permission or sharing permission, etc.) if the content satisfies the second privacy condition.

According to one embodiment, in operation 1030, the first electronic device 1001 may provide the first service associated with the content. For example, based on the device discovery signal (e.g., identification information or user information), the first electronic device 1001 may recognize information related to the second electronic device 1003 in the content. Or, for example, based on the privacy protection information, the first electronic device 1001 may delete or change the information related to the second electronic device 1003 in the content. Or, the first electronic device 1001 may associate the content and at least a part of the device discovery signal, and store the association result in the first electronic device 1001 or an external device (e.g., the server 480).

According to one embodiment, in operation 1040, the first electronic device 1001 may transmit a content acquisition notification to the second electronic device 1003. According to one embodiment, if the content includes or has a possibility of including information about the second electronic device 1003, the first electronic device 1001 may transmit the content acquisition notification to the second electronic device 1003. Or, if receiving the privacy protection information from the second electronic device 1003, the first electronic device 1001 may transmit the content acquisition notification to the second electronic device 1003. For example, the content acquisition notification may include a response (e.g., a processing result or negotiation information, etc.) to the privacy protection information. According to one embodiment, the content acquisition notification may include information requesting from the second electronic device 1003 information (e.g., content to be added or content to be substituted, etc.) associated with the content. For example, operation 1040 may include the content acquisition notification protocol 820.

According to one embodiment, the content acquisition notification may include at least one of a position, a direction, a time, a viewing angle, or identification information related to content. Or, the content acquisition notification may include at least a part (e.g., identification information or user information of the external device, etc.) of information that the first electronic device 1001 receives from an external device. For example, the external device receiving the content acquisition notification may use the identification information of the external device included in the content acquisition notification, to determine that the content acquisition notification includes the information associated with the external device. Or, the content acquisition notification may include at least a part (e.g., the entire content or a part related to the second electronic device 1003) of the content. According to one embodiment, the content acquisition notification may include the recognition request of [Table 1] above.

According to one embodiment, the content acquisition notification may include information requesting the second electronic device 1003 to acquire at least one of an audio, a video, or an image during a time of a designated duration or controlling the second electronic device 1003. For example, in response to the content acquisition notification, the second electronic device 1003 may acquire at least one content during at least a constant time. According to one embodiment, the content acquisition notification may include information requesting the second electronic device 1003 for information (e.g., user information of the second electronic device 1003 or other content, etc.) associated with the content. According to one embodiment, the first electronic device 1001 may transmit the content acquisition notification together with or before operation 1010 or operation 1030.

According to one embodiment, in operation 1050, the second electronic device 1003 may decide whether to respond to the content acquisition notification. For example, if the content acquired by the first electronic device 1001 includes or has a possibility of including information corresponding to the second electronic device 1003 or a user of the second electronic device 1003, the second electronic device 1003 may respond to the content acquisition notification. Or, if the first electronic device 1001 corresponds to a designated electronic device (e.g., a stored electronic device or user), the second electronic device 1003 may respond to the content acquisition notification. According to one embodiment, based on an input of a user of the second electronic device 1003, the second electronic device 1003 may decide whether to respond or not. Or, based on setting specified by the user of the second electronic device 1003 or a previous input, the second electronic device 1003 may automatically decide the response or non-response.

According to one embodiment, in operation 1060, the second electronic device 1003 may transmit a response to the content acquisition notification, to the first electronic device 1001. For example, the response may include a request (e.g., privacy protection information or sharing request, etc.) for the content acquired by the first electronic device 1001. For instance, the response may include a request for deletion, change, sharing, or substitution of the content. Or, the response may include at least one information (e.g., content of the second electronic device 1003, user information, or position information, etc.) requested by the first electronic device 1001. Or, the response may include information (e.g., object information or additional information) which is recognized using an object included in the content acquired by the first electronic device 1001.

According to one embodiment, in operation 1070, the first electronic device 1001 may provide the second service. For example, based on the response from the second electronic device 1003, the first electronic device 1001 may recognize information related to the second electronic device 1003 in the content. For example, if the second electronic device 1003 requests for sharing of the content, the first electronic device 1001 may transmit the content to the second electronic device 1003. For instance, based on whether the content includes information about the second electronic device 1003, the first electronic device 1001 may decide whether to transmit the content to the second electronic device 1003. According to one embodiment, at least one of operations 1020, 1040, or 1060 or a combination thereof may include at least a part of the protocol stack 800. According to one embodiment, operations 1020 and 1040 may be one operation.

According to one embodiment, in operation 1010, the first user of the first electronic device 1001 and the second user of the second electronic device 1003 may use the first electronic device 1001 together, to take a photo. For example, through operation 1020, the first electronic device 1001 may discover the second electronic device 1003 of the second user. According to one embodiment, the first electronic device 1001 and the second electronic device 1003 may have a connection with each other. The second electronic device 1003 may provide privacy protection information of the second user to the first electronic device 1001. For example, the second electronic device 1003 may provide privacy protection information requesting for deleting a photo in which the second user has his or her eyes closed (or, a photo in which the second user is squinting), to the first electronic device 1001. For example, in operation 1030, the first electronic device 1001 may delete the photo in which the second user closes the eyes, among one or more photos acquired from the first electronic device 1001, based on the privacy protection information of the second electronic device 1003.

According to one embodiment, in operation 1010, the first user of the first electronic device 1001 and the second user of the second electronic device 1003 may use the first electronic device 1001 together, to take a photo. Through operation 1040, the first electronic device 1001 may transmit notification information about the photo, to the second electronic device 1003. For example, the notification information may include at least a part of the photo. According to one embodiment, in operation 1050, the second electronic device 1003 may display the received notification information (e.g., a preview of the photo) to the second user of the second electronic device 1003. In operation 1060, based on an input of the second user corresponding to the notification information of the first electronic device 1001, the second electronic device 1003 may transmit a response to the first electronic device 1001. For example, the response may include a request for deletion of the photo. In operation 1070, the first electronic device 1001 may delete the photo. According to one embodiment, the second electronic device 1003 may include multiple electronic devices.

FIG. 11A and FIG. 11B are sequence diagrams of processes 1100a and 1100b, respectively, in which a first electronic device 1101 provides a service associated with content using a server 1105, according to various embodiments of the present disclosure.

According to one embodiment, referring to the process 1100a of FIG. 11A, the first electronic device 1101 (e.g., the electronic device 401) may transmit a notification associated with content to a second electronic device 1103 (e.g., the first external electronic device 403) through the server 1105 (e.g., the server 480).

According to one embodiment, in operation 1111, the first electronic device 1101 may transmit first position information of the first electronic device 1101 to the server 1105. In operation 1113, the second electronic device 1103 may transmit second position information of the second electronic device 1103 to the server 1105. For example, the first electronic device 1101 or second electronic device 1103 may use a communication standard such as Tracking Area Update (TAU), to transmit the first position information or second position information to the server 1105 (e.g., an eNode B, an application server, or an MME, etc.). Or, the first electronic device 1101 or second electronic device 1103 may transmit the first position information or second position information which is measured using at least a part of information acquired using a sensor module (e.g., a GPS or gyro sensor, etc.), to the server 1105 (e.g., an SNS server or a presence server, etc.), respectively. Or, the first electronic device 1101 or second electronic device 1103 may transmit the first position information or second position information which is measured using information (e.g., a cell ID, a sector ID, a MAC address, or a radio fingerprint, etc.) received from a wireless network (e.g., a cellular network or a Wi-Fi network) or at least a part of the received information, to the server 1105 (e.g., the SNS server or the presence server, etc.), respectively. According to one embodiment, in operation 1115, the server 1105 may check a position of the first electronic device 1101 or second electronic device 1103.

According to one embodiment, in operation 1117, the first electronic device 1101 may acquire content. In operation 1119, the first electronic device 1101 may transmit a first notification of the content acquisition to the server 1105. For example, the first notification may include information (e.g., identification information or position information, etc.) about the first electronic device 1101 or information (e.g., a time, a type, a position, or a direction, etc.) associated with the content. Or, the first notification may include at least a part of the content or information (e.g., eigenface or sound wave signature, etc.) corresponding to the content.

According to one embodiment, in operation 1121, the server 1105 may transmit a second notification to the second electronic device 1103. For example, the server 1105 may decide an electronic device associated with the content, based on at least one of the first position information or first notification of the first electronic device 1101. For example, the server 1105 may compare information (e.g., a position or a time, etc.) of the first notification and the first position information, and decide if the second electronic device 1103 is associated with the content. For instance, if the first electronic device 1101 and the second electronic device 1103 are located in the same cell, the server 1105 (e.g., an eNode B or an MME, etc.) may decide that the second electronic device 1103 is associated with the content. The server 1105 may transmit the second notification to the electronic device associated with the content. According to one embodiment, the second notification may include at least a part of the first notification. Or, the second notification may include a request for checking whether the second electronic device 1103 is associated with the content.

According to one embodiment, in operation 1123, the second electronic device 1103 may transmit a first response to the second notification, to the server 1105. For example, the first response may include a response to a content request (e.g., privacy protection information or content sharing request, etc.) or a checking request. According to one embodiment, in operation 1125, the server 1105 may transmit a second response to the first electronic device 1101, in response to the first response. For example, the second response may include at least a part of the first response. According to one embodiment, in operation 1127, the first electronic device 1101 may provide a service of content (e.g., privacy protection, sharing, or change of at least a part of the content, etc.), in response to the second response.

According to one embodiment, referring to the process 1100b of FIG. 11B, the first electronic device 1101 may receive information corresponding to adjacent devices from the server 1105. For example, the first electronic device 1101 may provide a service associated with content, based on the received information.

According to one embodiment, in operation 1131, the first electronic device 1101 may transmit first position information of the first electronic device 1101 to the server 1105. In operation 1133, the second electronic device 1103 may transmit second position information of the second electronic device 1103 to the server 1105. For example, the first position information or second position information may include privacy protection information of the first electronic device 1101 or second electronic device 1103, respectively. According to one embodiment, in operation 1135, the server 1105 may check a position of the first electronic device 1101 or second electronic device 1103. For example, the server 1105 may compare the first position information and the second position information, and determine if the first electronic device 1101 and the second electronic device 1103 are adjacent to each other.

According to one embodiment, in operation 1137, the server 1105 may transmit first request information to the first electronic device 1101. For example, the first request information may include privacy protection information of an electronic device (e.g., the second electronic device 1103) adjacent to the first electronic device 1101. For instance, if the first electronic device 1101 acquires content including information corresponding to the second electronic device 1103, the privacy protection information may include a request of the second electronic device 1103 requesting at least one service (e.g., deletion or sharing, etc.) associated with content.

According to one embodiment, in operation 1139, the server 1105 may transmit second request information to the second electronic device 1103. For example, the second request information may include privacy protection information of an electronic device (e.g., the first electronic device 1101) adjacent to the second electronic device 1103. According to one embodiment, in operation 1141, the first electronic device 1101 may acquire content. According to one embodiment, in operation 1143, the first electronic device 1101 may provide a service associated with the content, based on the first request information. For example, if the first electronic device 1101 receives the privacy protection information of the second electronic device 1103 of, at the time of acquiring an image including a designated look of a user of the second electronic device 1103, requesting to delete or substitute at least a part of the image with designated content, the first electronic device 1101 may delete or substitute the at least part of the image with the designated content.

FIG. 12A and FIG. 12B are sequence diagrams of processes 1200a and 1200b, respectively, according to an embodiment of the present disclosure.

According to one embodiment, referring to the process 1200a of FIG. 12A, a first electronic device 1201 (e.g., the electronic device 401) may provide a notification of content sharing to a second electronic device 1203 (e.g., the electronic device 403), and provide a service associated with content, based on a response to the notification.

According to one embodiment, in operation 1211, the first electronic device 1201 may decide to share content with a third electronic device 1205 (e.g., the electronic device 405). For example, the first electronic device 1201 may identify other electronic device associated with the content. For instance, the first electronic device 1201 may determine if information about the other electronic device (e.g., the second electronic device 1203) has been included in the content to be shared. For instance, the first electronic device 1201 may use at least one of the device discovery protocol 810 or the content acquisition notification protocol 820, to identify the other electronic device associated with the content.

According to one embodiment, in operation 1213, the first electronic device 1201 may transmit a sharing notification to the second electronic device 1203. For example, the sharing notification may include the sharing notification protocol 830. For example, the sharing notification may include at least one of information about the first electronic device 1201, information about the content, or information about the electronic device (e.g., the third electronic device 1205) which will share. According to one embodiment, the second electronic device 1203 may determine if the content includes information related to the second electronic device 1203, based on the sharing notification.

According to one embodiment, in operation 1215, the second electronic device 1203 may transmit a response to the first electronic device 1201. For example, the response may include a content request (e.g., sharing prohibition or content change, etc.). Or, the response may include the information related to the second electronic device 1203 included in the content. According to one embodiment, if the content includes the information related to the second electronic device 1203, the second electronic device 1203 may transmit the response to the first electronic device 1201. Or, the second electronic device 1203 may transmit the response to the first electronic device 1201 such that the response includes information about whether the content includes the information related to the second electronic device 1203.

According to one embodiment, in operation 1217, in response to the response, the first electronic device 1201 may provide a service associated with the content. For example, the first electronic device 1201 may change at least a part of the content. Or, the first electronic device 1201 may use the negotiation protocol 840, to negotiate the content change with the second electronic device 1203, and change the content. Or, the first electronic device 1201 may use the negotiation protocol 840, to negotiate (e.g., a change of a part of the content, etc.) sharing prohibition with the second electronic device 1203, and share the content. According to one embodiment, in operation 1219, the first electronic device 1201 may share the content with the third electronic device 1205.

According to one embodiment, referring to the process 1200b of FIG. 12B, the first electronic device 1201 may provide a notification of content sharing to the second electronic device 1203. The server 1207 may provide a service (e.g., privacy protection information, etc.) associated with the content, based on a response to the notification.

According to one embodiment, in operation 1231, the first electronic device 1201 may transmit content to the server 1207. For example, the first electronic device 1201 may share the content with at least one other electronic device through the server 1207. For instance, the server 1207 may transmit the received content to the other device. According to one embodiment, the first electronic device 1201 may transmit the content and information associated with the content to the server 1207. For example, the information associated with the content may include information (e.g., an external device associated with the content) acquired through the device discovery protocol 810 or the content acquisition notification protocol 820.

According to one embodiment, in operation 1233, in response to the content reception, the server 1207 may transmit a content sharing notification to the second electronic device 1203. For example, the server 1207 may use the information associated with the content, to identify the second electronic device 1203. Based on identified information, the server 1207 may transmit the sharing notification to the second electronic device 1203. For instance, the sharing notification may include at least one of information about the first electronic device 1201, information about the content, or information about the identified second electronic device 1203. According to one embodiment, the sharing notification may include privacy protection information of the second electronic device 1203. For example, the sharing notification may include information about processing (e.g., sharing prohibition, deletion, substitution, or change, etc.) of information about the second electronic device 1203 included in the content. According to one embodiment, the sharing notification may include the negotiation protocol 840.

According to one embodiment, in operation 1235, the second electronic device 1203 may transmit a response to the sharing notification, to the server 1207. For example, the second electronic device 1203 may decide the response based on a user input corresponding to the sharing notification of a user of the second electronic device 1203, and transmit the decided response to the server 1207. Or, the second electronic device 1203 may automatically decide the response, based on information designated by the user or information learned from the user, and transmit the decided response to the server 1207. For example, the response may include privacy protection information. Or, the response may include a content sharing request. According to one embodiment, in operation 1237, in response to the response, the server 1207 may provide a service of the content. For example, the server 1207 may change at least a part of the content, and transmit the changed content to at least one other device. Or, the server 1207 may transmit the content to the second electronic device 1203.

According to one embodiment, the process 1200b may omit at least one of operation 1233 or operation 1235. For example, the server 1207 may store privacy protection information of the second electronic device 1203. In response to content reception, the server 1207 may use the privacy protection information of the second electronic device 1203, to provide a service associated with content. According to one embodiment, the privacy protection information may include a permission user list. For example, if content includes information associated with the second electronic device 1203, a designated device or designated user of the privacy protection information may not make a request for the content.

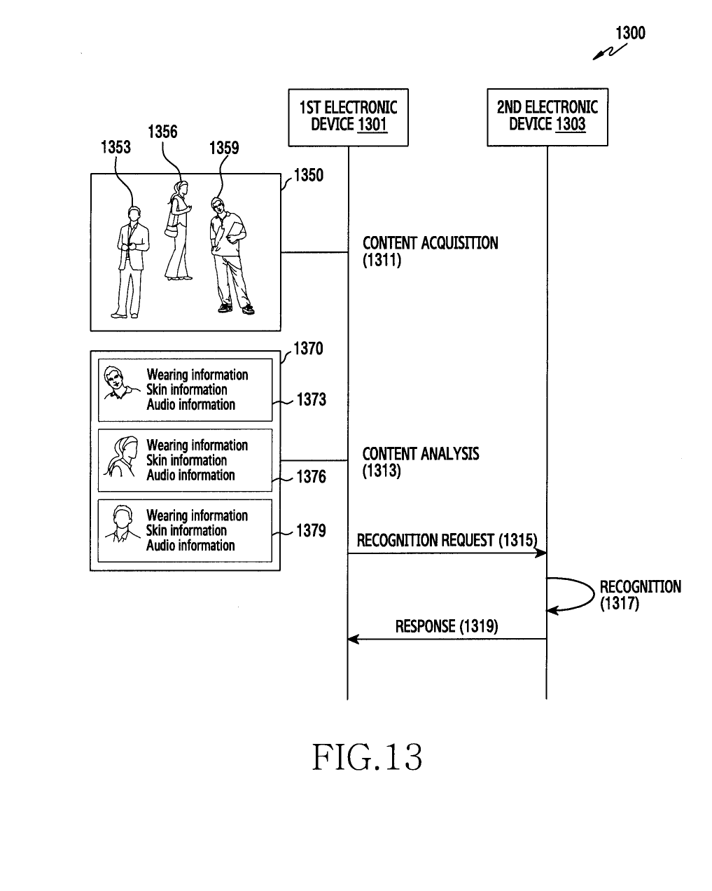

FIG. 13 is a sequence diagram of an example of a process 1300, according to an embodiment of the present disclosure.

According to one embodiment, referring to FIG. 13, a first electronic device 1301 (e.g., the electronic device 401) may recognize an object included in content, through a second electronic device 1303 (e.g., the electronic device 403 or the server 480).

According to one embodiment, in operation 1311, the first electronic device 1301 may acquire content 1350. For example, the content 1350 may represent (e.g., depict) first to third objects 1353, 1356, and 1359. According to one embodiment, in operation 1313, the first electronic device 1301 may process the content 1350 and generate information 1370 associated with at least one of the objects 1353, 1356, and 1359 included in the content 1350. For example, the first electronic device 1301 may analyze the content 1350, and generate information 1373 corresponding to the first object 1353. For instance, the information 1373 corresponding to the first object 1353 may include at least a part of the content or a feature (e.g., eigenface (e.g., or another type of signature suitable for representing faces), costume information, skin tone pattern (e.g., or another type of signature suitable for representing the color scheme of at least a portion of the content) or audio information, etc.) extracted using the at least part of the content. Also, the first electronic device 1301 may generate information 1376 and 1379 corresponding to the second and third objects 1356 and 1359, respectively.

According to one embodiment, in operation 1315, based on the information about the objects, the first electronic device 1301 may transmit a recognition request corresponding to at least one object, to the second electronic device 1303. For example, the recognition request may include the recognition request shown in [Table 1] above. In some implementations, the recognition request may include at least one of a portion of the content representing the object and/or information corresponding to the object that is generated in operation 1313. According to one embodiment, in operation 1317, based on the recognition request, the second electronic device 1303 may perform object recognition. For example, the second electronic device 1303 may perform the object recognition using a database to which the second electronic device 1303 may gain access. According to one embodiment, in operation 1319, the second electronic device 1303 may transmit a response to the first electronic device 1301. For example, the response may include any suitable type of information related to the object, such as an identifier corresponding to the object, etc.

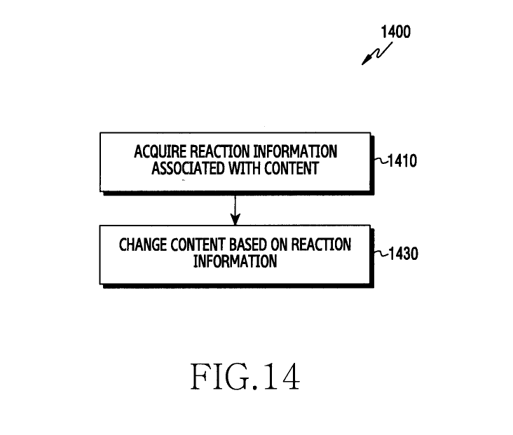

FIG. 14 is a flowchart of an example of a process 1400, according to an embodiment of the present disclosure.

According to one embodiment, in operation 1410, the electronic device (e.g., the content service module 420 or the content service server module 486) may acquire reaction information associated with a content. For example, the electronic device may provide output the content (e.g., display or play via a speaker), and use an input device (e.g., the sensor module 413 or the sensor device 430, etc.) operatively connected to the electronic device, to acquire reaction information from the user of the electronic device.

According to one embodiment, the electronic device may provide the content to the user through a user interface (e.g., a display, a speaker, etc.) operatively connected to the electronic device, and acquire speaking, behavior, or look, etc. that the user performs in relation with the content through the input device. For instance, the electronic device may acquire linguistic information (e.g., a text) that the user inputs in relation with the content or information that the user selects (e.g., selects at least a part of the content). According to one embodiment, the electronic device may automatically acquire speech uttered by the user when the content is output (e.g., a voice recording of the user), an indication of the behavior of the user when the content is output, or an indication of a facial expression made by the user when the content is output (e.g., an image of the user). According to one embodiment, the electronic device may provide the content through an SNS, and acquire reaction information associated with the content through the SNS.

According to one embodiment, in operation 1430, the electronic device may change the content, based on the reaction information. For example, the electronic device may use the reaction information (e.g., dark), to brighten at least a part of the content. According to one embodiment, the reaction information may include information such as “look at skin blemishes”, “image is a little too dark”, “the lower lip was made too thick”, or “even eyes a little bigger”. For example, if the string “even eyes a little bigger” is acquired as reaction information, the electronic device may modify an image corresponding to a person's eyes. For instance, based on information having changed similar content, the electronic device may change (e.g., enlarge) the image corresponding to the eyes. For example, if information “the image is a little dark” is inputted by a user, the electronic device may brighten the image.

According to one embodiment, the reaction information may include reaction information such as “background music is noisy”, “if there was exciting music”, “if background music was off here”, “if zoomed in”, “too long”, “bored”, “laugh”, “look again”, “shy”, or “cute”. For example, based on the reaction information “look again”, the electronic device may cause the content to loop a predetermined number of times. Or, based on the reaction information “if zoomed in”, the electronic device may change the content to zoom-in a certain area. Or, based on the reaction information “here is bored” or “too long”, the electronic device may delete a portion of the content or apply a designated effect to the content. Or, based on the reaction information “laugh”, the electronic device may apply a designated effect (e.g., a laugh track, an applause track, an avatar, or an animation, etc.) to the content. Or, based on the reaction information such as “background music is noisy”, “if there was exciting music”, or “if background music was off here”, the electronic device may change background music of the content. Or, based on the reaction information “shy”, the electronic device may apply an effect (e.g., an effect of making a certain area of a person's cheek red) to a certain area (e.g., the cheek) of the content. Or, based on the reaction information “cute”, the electronic device may apply an image (e.g., a cute bear) to a certain area (e.g., an area where a person is depicted) of the content.

According to one embodiment, the electronic device may use first reaction information of a first user and second reaction information of a second user about content, to change the content. For example, based on the first reaction information (e.g., face is too close), the electronic device may identify a first region of the content in which the face of a person is depicted. The electronic device may then change (e.g., scale down) the first region to cause the face to appear further away from the camera that captured the content. For example, based on the second reaction information (e.g., “eyes closed” or “hair is messy”, etc.), the electronic device may identify a second region (e.g., eyes or head of the second user, etc.) corresponding to the second user or second reaction information, in the content. The electronic device may use the second reaction information, to change (e.g., substitute with an image of opened eyes or delete a portion of the image that depicts a person's hair, etc.) the second region.

FIG. 15 is a flowchart of an example of a process 1500, according to an embodiment of the present disclosure.

According to one embodiment, in operation 1510, the electronic device (e.g., the narration information module 610) may acquire content. For example, the electronic device may generate the content (e.g., an image, a video, an audio, or a document, etc.) through an input device (e.g., the sensor module 413 or the sensor device 430, etc.) operatively connected to the electronic device. Or, the electronic device may receive the content from an external device for the electronic device.

According to one embodiment, in operation 1530, the electronic device may identify information associated with the content. For example, the information associated with the content may include information acquired through the protocol stack 800 and it may be associated with an external device or a user of the external device. For example, the information associated with the content may include at least one of biophysical information, user information, schedule information, emotion information, payment information, sharing information, sensor information, or object recognition information, acquired from the electronic device in association with the content.

According to one embodiment, in operation 1550, the electronic device may provide narration information corresponding to the content. For example, the electronic device may generate narration information corresponding to the content, based on the information associated with the content, and provide the content together with the narration information. Providing the narration information may include at least one of outputting the narration information by the electronic device (e.g., via a display or speaker of the electronic device), and transmitting the narration information to one or more external devices. For example, if transmitting the content to an external device, the electronic device may provide the content and the narration information to the external device. Or, if displaying the content on a display, the electronic device may display the narration information in association with the content. Additional information about providing the narration information is provided with reference to FIG. 16 or FIG. 17 described later.

FIG. 16 is a diagram illustrating an example 1600 of the operation of the process of FIG. 15, according to an embodiment of the present disclosure.

Referring to FIG. 16, in the example 1600, the electronic device (e.g., the content service module 420 or the content service server module 486) may provide at least one narration information item corresponding to content 1621. According to one embodiment, the electronic device may use at least one of position information, accompanying information, movement path information, or schedule information associated with the content 1621, to provide the narration information. For example, the electronic device may use the position information to provide the narration information 1623 “Near tower bridge”. Additionally or alternatively, the electronic device may recognize an object included in the content 1621, and provide the narration information 1623 “Near tower bridge”. For example, the electronic device may use the accompanying information to provide narration information 1625 “With Clair”. For instance, the electronic device may use information acquired through the protocol stack 800 to identify the accompanying information.

For example, the electronic device may use the movement path information, to provide narration information 1627 including the string “At the night, we arrived in LD”. Or, additionally or alternatively, the electronic device may use the schedule information, to provide the narration information 1627 including the string “At the night, we arrived in LD”. For example, the electronic device may use at least one of the movement path information or the companying information, to provide narration information 1629 including the string “We walked around the LD through the night”. For instance, the electronic device may use the movement path information of the electronic device after time information corresponding to the content 1621, to provide narration information. The electronic device may use the movement path information and the companying information, to identify that a user of the electronic device and another user (e.g., Clair) have moved together.

According to one embodiment, the electronic device may use at least one of movement information or accompanying information associated with the content 1621, to provide at least one of narration information (e.g., 1631 or 1639). For example, the movement information may include at least one of position information, movement means information (e.g., an identification of a type of transportation used by a user), or movement path information (e.g., an identification of a travel path followed by the user). For example, the electronic device may use the movement path information, to display narration information 1633 including an image of a travel path from a first position (e.g., A) to a second position (e.g., B). Or, the electronic device may use the movement path information, to provide the narration information 1639 including the string “from A to B”.

According to one embodiment, the electronic device may use the movement means information, to display narration information (e.g., 1635) corresponding to a movement means. Or, the electronic device may use the movement means information, to provide the narration information 1639 including the string “car trip”. For example, the electronic device may provide as the narration information a walking animation, an animation moving by car, an animation going by airplane, an animation going by ship, etc. According to one embodiment, the electronic device may use the companying information, to display narration information 1637 including an image corresponding to a companion. Or, the electronic device may use the accompanying information, to provide the narration information 1639 including the string “with Kim and Clair”.

According to one embodiment, the electronic device may use the movement information, to provide the narration information 1639 including the string “holiday car trip”. For example, the electronic device may use the movement information, to determine a daily movement path of the electronic device. For instance, if a user of the electronic device has a job, the electronic device may identify movement information centering on certain positions such as a home, a job, or a village, etc. on weekdays. For instance, if identifying movement information moving to other position not being the certain positions on a weekend or holiday, the electronic device may identify that it is a weekend or holiday trip.

According to one embodiment, the electronic device may use movement information and accompanying information, to generate narration information including the image 1651. For example, the electronic device may identify first movement information corresponding to a first user 1661 and second movement information corresponding to a second user 1663. For instance, the electronic device may identify the first movement information in which the first user 1661 moves from a first position (e.g., D) to a second position (e.g., E), and moves from the second position (e.g., E) to a third position (e.g., F). The electronic device may identify the second movement information in which the second user 1663 moves from a fourth position (e.g., C) to the second position (e.g., E), and moves from the second position (e.g., E) to the third position (e.g., F).

The electronic device may generate first comparison information (e.g., movement information from E to F) in which the first movement information and the second movement information match with each other, or second comparison information (e.g., movement information from D to E and movement information from C to E) in which the first movement information and the second movement information do not match with each other. The electronic device may provide the narration information including the image 1651 such that the narration information includes at least one of the first comparison information or the second comparison information. Also, the electronic device may provide an animation in which the first user 1661 moves from the first position (e.g., D) to the second position (e.g., E) or an animation in which the second user 1663 moves from the fourth position (e.g., C) to the second position (e.g., E). Also, the electronic device may provide an animation in which the first user 1661 and the second user 1663 move from the second position (e.g., E) to the third position (e.g., F), together.

FIG. 17 is a diagram illustrating an example 1700 of the operation of the process of FIG. 15, according to an embodiment of the present disclosure.

Referring to FIG. 17, in the example 1700, the electronic device may provide narration information corresponding to content in association with the content. As illustrated, in the example 1700, the content may include a call history log.

According to one embodiment, in an example 1711, the electronic device may display content (e.g., call history items 1723, 1727, and 1731 or an e-mail history 1735, etc.) corresponding to a designated user (e.g., Tom). Also, the electronic device may use information associated with the content, to provide narration information (e.g., 1725, 1729, 1733, or 1737) corresponding to different portions of the content. For example, the electronic device may use movement path information, movement means information, or emotion information, to provide the narration information 1725 including the string “in bus, going home after leaving office, getting angry”. For example, the electronic device may use position information or companying information, to provide the narration information 1729 including the string “at office with John”. For instance, the electronic device (e.g., by using the companying information module 641) may identify generate narration information including the string “with John” by recognizing a speaker based on an audio corresponding to a call. Or, the electronic device (e.g., the companying information module 641) may generate the narration information including the string “with John” through the protocol 810.

According to one embodiment, the electronic device may use schedule information, to generate the narration information 1733 which includes the string “in conference A”. For example, the electronic device may use information (e.g., Bluetooth connection information, etc.), to provide the narration information 1737 which includes the string “with hands-free in car”. According to one embodiment, in an example 1741, the electronic device may provide narration information 1745 corresponding to content (e.g., an entry in a list of contacts) 1743. For example, the electronic device may use sharing information (e.g., an acquiring device or a providing user, etc.) corresponding to the content, to provide the narration information 1745 which includes the string “phone number provided by Kim”.

FIG. 18 is a diagram illustrating an example 1800 of the operation of the process of FIG. 15, according to an embodiment of the present disclosure.

For example, the electronic device may use a sensor module (e.g., the camera module 291) operatively connected to the electronic device, to acquire content 1810. Although in this example the content 1810 includes an image, in some implementations, the content may include audio, and or any other suitable type of media. For example, the content 1810 may include a subject 1816 photographed intentionally and a subject 1813 photographed unintentionally. For instance, the electronic device may transmit the content 1810 or information associated with the content to an external device (e.g., the first external electronic device 403 or the second external electronic device 405) corresponding to the subject 1813, through at least one of the device discovery protocol 810 or the acquisition notification protocol 820. In response, the electronic device may receive privacy protection information corresponding to the subject 1813 from the external device, through at least one of the device discovery protocol 810 or the acquisition notification protocol 820.

According to one embodiment, based on the privacy protection information corresponding to the subject 1813, the electronic device may modify the content 1810 to generate content 1830. For example, the privacy protection information may include information requesting the deletion to the subject 1813 from the content 1810. Based on the deletion request, the electronic device may delete the subject 1813 from the content 1810, to generate the content 1830. If the content 1830 meets a designated condition (e.g., a change of one portion of a main subject, etc.), the electronic device may negotiate the content change with the external device. For instance, if a part 1833 of the subject 1816 is changed when the electronic device deletes the subject 1813 from the content 1830, the electronic device may negotiate the content change with the external device.

According to one embodiment, the electronic device may transmit a proposal for content change to the external device. For example, the electronic device may transmit to the external device negotiation information proposing that the content 1813 be blurred. For instance, the electronic device may negotiate with the external device, through the negotiation protocol 840. For instance, the electronic device may transmit at least a part of content 1850 including a blur processing result 1853 of the subject 1813, to the external device. Based on permission information designated by a user, the external device may accept the blur processing result 1853. Or, the external device may provide information about the blur processing result 1853 to the user, and use a user's input corresponding to this to respond to the electronic device. Based on the response of the external device, the electronic device may replace the content 1810 with the content 1850.

FIG. 19 is a diagram illustrating an example 1900 of the operation of the process of FIG. 15, according to an embodiment of the present disclosure.

According to one embodiment, in a screen 1910, the electronic device may provide first content 1915 in association with narration information 1917 corresponding to the first content 1915. For example, the electronic device may use a protocol (e.g., the device discovery protocol 810 or the acquisition notification protocol 820, etc.), to provide the narration information 1917 “with Clair”. According to one embodiment, in a screen 1920, the electronic device may use sharing information, to change (e.g., augment) the narration information 1517. For example, the electronic device may transmit the first content 1915 or the narration information 1917 to an external device (e.g., the first external electronic device 403, the second external electronic device 405, or the server 480, etc.) and then use sharing information that is created when the transmission takes place to modify the narration information 1517 to provide narration information 1921.

According to one embodiment, in a screen 1930, the electronic device may acquire other content (e.g., an audio or an image, etc.) associated with content (e.g., the first content 1915). For example, the electronic device may receive the other content from the external device. The other content may be generated (e.g., captured) by the external device or it may be received by the external device from a third-party source. For instance, the other content may include an audio, an image, a text, or a video corresponding to the content (e.g., the first content 1915). For example, the electronic device may provide narration information 1931 including information about the other content.

According to one embodiment, as shown in screen 1940, the electronic device may add other content to the content 1915. For example, the electronic device may add other content 1947 (e.g., an image) to the first content 1915, to generate a second content 1945. For instance, the electronic device may receive the other content 1947 associated with the first content 1915 from the external device, and display the second content 1945 which includes the other content 1947 and the first content 1915. For instance, the electronic device may use information (e.g., a position, a time, planning, a viewing angle, or a direction, etc.) corresponding to the first content 1915 or the other content 1947, as a basis for combining the content 1947 with the first content 1915. The electronic device may use the information corresponding to the first content 1915 or the other content 1947, to change at least attribute of the first content 1915 and/or the other content 1947 (e.g., a size, a position, orientation, etc.) each corresponding to the first content 1915 or the other content 1947 and combine the other content 1947 with the first content 1915. After the first content 1915 is combined with the other content 1947, the electronic device may provide the narration information 1941 which includes the string “combined with Kim's image”.

According to one embodiment, in a screen 1950, the electronic device may add a link 1955 which when selected (e.g., clicked) causes audio associated with the content 1945 to be played. For example, the electronic device may identify a region in the content 1945 where a particular person or object is portrayed (e.g., an image corresponding to Clair) and add the link 1955 in association with the identified region. According to one embodiment, the electronic device may provide narration information 1951 including the string “Inserted Clair's audio” when the link 1955 is added.

A content providing method of an electronic device according to various embodiments of the present disclosure may include the operations of acquiring one or more contents through a sensor module operatively connected to the electronic device in the electronic device, and transmitting notification information about the one or more contents, to an external device for the electronic device, and receiving a response corresponding to the notification information from the external device, and changing the one or more contents based on the response.

The changing operation according to various embodiments of the present disclosure may include the operation of, based on the response, generating narration information corresponding to the one or more contents associated with the external device, and providing the one or more contents in association with the narration information. The generating operation according to various embodiments of the present disclosure may include the operation of providing movement information about at least one of the electronic device or the external device, as at least a part of the narration information.

The method according to various embodiments of the present disclosure may include the operations of identifying a sharing request for the one or more contents based on the response, and sharing at least a part of the one or more contents with the external device if the one or more contents include information (e.g., information corresponding to a user of the external device, etc.) corresponding to the external device. The method according to various embodiments of the present disclosure may include the operation of transmitting the notification information to the external device, before acquiring the one or more contents.

The changing operation according to various embodiments of the present disclosure may include the operations of identifying reaction information of a user of the external device about the one or more contents, based on the response, and changing the one or more contents based on the reaction information.

The changing operation according to various embodiments of the present disclosure may include the operations of based on first reaction information of a first user and second reaction information of a second user about the one or more contents, changing a first area corresponding to the first user or the first reaction information in the one or more contents, and, based on the second reaction information, changing a second area corresponding to the second user or the second reaction information in the one or more contents.

The changing operation according to various embodiments of the present disclosure may include the operations of deciding to share the one or more contents with other external device, and transmitting the notification information to the external device such that the notification information includes information associated with the sharing.

The changing operation according to various embodiments of the present disclosure may the operations of identifying a first request of the external device for the one or more contents, based on the response, and transmitting negotiation information corresponding to the first request to the external device, and receiving an additional response to the negotiation information from the external device, and identifying a second request for the one or more contents in the additional response, and changing the one or more contents based on the second request.

A content providing method of an electronic device according to various embodiments of the present disclosure may include the operations of receiving at least one of a position of an external device, a time, identification information from the external device, and determining if one or more contents include information associated with the external device based on the at least one, and transmitting notification information to the external device if the one or more contents include the information associated with the external device.

The method according to various embodiments of the present disclosure may the operations of identifying other content associated with the one or more contents based on the response, and presenting at least a part of the other content and link information about this in association with the one or more contents.

The method according to various embodiments of the present disclosure may include the operations of identifying an audio acquired from the external device based on the response, and use the acquired audio to change at least a part of an audio included in the one or more contents.

The method according to various embodiments of the present disclosure may include the operation of including, in the notification information, information requesting the external device to acquire at least one of an audio, a video, or an image during a time of a designated duration. The method according to various embodiments of the present disclosure may include the operation of including, in the notification information, information requesting the external device to recognize at least one object included in the one or more contents.

The method according to various embodiments of the present disclosure may include the operations of acquiring at least one information among identification information about an external device or feature information about a user of the external device, based on the response, and recognizing at least one object corresponding to the external device or the user of the external device in the one or more contents, based on the at least one information. The content service module according to various embodiments of the present disclosure may delete or change one portion corresponding to the user of the external device in the one or more contents.

The changing operation according to various embodiments of the present disclosure may include the operations of determining if the one or more contents include information corresponding to the external device or at least one object corresponding to the user of the external device, and executing the change based on the response only if the one or more contents include the at least one object.

A content providing method of an electronic device according to various embodiments of the present disclosure may include the operations of acquiring one or more contents, identifying first information corresponding to at least one of an external device for the electronic device or a user of the external device, received from the external device, in association with the one or more contents, and providing narration information corresponding to the one or more contents such that the narration information includes second information associated with the at least one, generated using the first information. The first information according to one embodiment may include at least one of position information corresponding to the external device, address information, account information, or identification information.

The identifying operation according to various embodiments of the present disclosure may include the operation of using a directive communication module operatively connected with the electronic device, to transmit a request associated with the first information to the external device located in a position associated with the one or more contents.

The providing operation according to various embodiments of the present disclosure may include the operations of comparing first position information corresponding to the at least one, acquired using the first information and second position information corresponding to the one or more contents, and providing the narration information such that, if a position indicated by the first position information and a position indicated by the second position information are within a defined range, the narration information includes the second information.

The providing operation according to various embodiments of the present disclosure may include the operations of using the first information, to identify type information or use state information of the external device, and by using the type information or use state information, using position information of the external device as position information of the user of the external device, to generate the second information.

The providing operation according to various embodiments of the present disclosure may include the operations of inserting, substituting, or connecting other content to at least a part of the one or more contents, and providing the narration information such that the narration information includes third information generated in relation with the other content. The one or more contents according to various embodiments of the present disclosure may include first content acquired in the electronic device or second content acquired in the external device.

The providing operation according to various embodiments of the present disclosure may include the operations of recognizing at least one object among a plurality of objects included in the one or more contents, determining at least one position information corresponding to the one or more contents, based on the at least one object, and providing the narration information such that the narration information includes third information generated using the at least one position information.

The providing operation according to various embodiments of the present disclosure may include the operations of identifying first movement information corresponding to the electronic device and second movement information corresponding to the external device, generating first comparison information associated with both the first movement information and the second movement information, or second comparison information associated with only one of the first movement information or the second movement information, and providing the narration information such that the narration information includes at least one of the first comparison information or the second comparison information.

The narration information according to various embodiments of the present disclosure may include first narration information corresponding to a first external device or second narration information corresponding to a second external device, and the providing operation may include the operations of transmitting the first narration information to the first external device, and transmitting the second narration information to the second external device.

The providing operation according to various embodiments of the present disclosure may include the operations of using a biophysical sensor operatively connected with the electronic device, to identify biophysical information corresponding to a user of the electronic device, and providing the narration information such that the narration information includes third information related with a health of the user of the electronic device, generated using the biophysical information.

The providing operation according to various embodiments of the present disclosure may include the operations of acquiring third information corresponding to at least one of the electronic device or a user of the electronic device, and generating the narration information including the second information, such that the second information includes fourth information generated by comparing one portion of at least the first information and a corresponding portion of the third information with each other.

The providing operation according to various embodiments of the present disclosure may include the operations of identifying a movement path related with movement of the external device from a first position to a second position, from the first information, and generating the narration information including the second information, such that the second information includes third information generated based on at least one of the first position, the second position, and the movement path.

The providing operation according to various embodiments of the present disclosure may include the operations of identifying a movement means related with movement of the external device, from the first information, and generating the narration information including the second information, such that the second information includes at least one of a text, an image, or a video generated based on the movement means.

The providing operation according to various embodiments of the present disclosure may include the operations of generating third information associated with an emotion or mood corresponding to the one or more contents, based on the first information or the one or more contents, and generating the narration information such that the narration information includes the third information.

The providing operation according to various embodiments of the present disclosure may include the operations of identifying reaction information about the one or more contents acquired from the user of the external device, from the first information, and generating the narration information including the second information, such that the second information includes the reaction information.

The providing operation according to various embodiments of the present disclosure may include the operations of identifying other narration information corresponding to the one or more contents generated in the external device, and generating the narration information including the second information, such that the second information includes third information generated using at least a part of the other narration information.

The providing operation according to various embodiments of the present disclosure may include the operations of identifying third information about the electronic device or a user of the electronic device, compare the first information and the third information, and generating first comparison information associated with both the first information and the third information, or second comparison information associated with only one of the first information or the third information, and generating the narration information including the second information, such that the second information includes at least one of the first comparison information or the second comparison information.

A content providing method of an electronic device according to various embodiments of the present disclosure may include the operations of acquiring one or more contents in the electronic device, identifying reaction information corresponding to the one or more contents, and using the reaction information to change the one or more contents.

A content providing method of an electronic device according to various embodiments of the present disclosure may include the operations of identifying at least one of a first content and first position information or first direction information of the first content, as first information, and identifying at least one of a second content and second position information or second direction information of the second content, as second information, and using the first information and the second information, to synthesize at least a part of the first content and at least a part of the second content.

A method and apparatus according to various embodiments of the present disclosure may, for example, provide content and various services associated with the content, through an electronic device. The method and apparatus according to the various embodiments of the present disclosure may, for example, provide narration information corresponding to the content, through the electronic device.

Or, a method and apparatus according to various embodiments of the present disclosure may provide a change of content. Or, the method and apparatus according to the various embodiments of the present disclosure may provide a notification of content acquisition to an external device.

Or, a method and apparatus according to various embodiments of the present disclosure may request an external device for a change of content acquired by the external device.

FIGS. 1-19 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. As noted above, aspects of the disclosure are related to generating narration information related to a content item based on at least one information item. The content item may include any suitable type of one or more contents. For example, the content item may include one or more of an image, an image generated by combining two or more images, multiple images, audio, video, and animation. The narration information may include any suitable type of media, such as one or more of a still image, text, video, or audio, and/or interactive content, such as a link, etc. The information item may include any suitable type of information that is generated locally and/or obtained from one or more external sources. For example, and without limitation, the information item may include one or more of biophysical information, user information, schedule information, emotion information, payment information, sharing information, sensor information, or object recognition information, acquired from the electronic device in association with the content.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An electronic device comprising:
a memory for storing a content item; and
at least one processor operatively coupled to the memory, configured to:
acquire a first information item corresponding to at least one of an external device or a user of the external device,
generate narration information corresponding to the content item based at least in part on the first information item, and
provide the content item and the narration information.

2. The electronic device of claim 1, wherein:
the at least one processor is further configured to acquire biophysical information corresponding to a user of the electronic device by using a biophysical sensor operatively coupled to the electronic device, and
the narration information is further generated based on the biophysical information.

3. The electronic device of claim 1, wherein:
the at least one processor is further configured to acquire a second information item associated with at least one of the electronic device or a user of the electronic device, and
the narration information is generated by comparing the first information item with the second information item.

4. The electronic device of claim 1, wherein:
the at least one processor is further configured to identify a movement path of the external device from a first position to a second position based on the first information item, and
the narration information is generated based on at least one of the first position, the second position, and the movement path.

5. The electronic device of claim 1, wherein:
the at least one processor is further configured to identify a type of transportation associated with the electronic device, and
the narration information includes at least one of a text, an image, or a video that is generated based on the type of transportation associated with the external device.

6. The electronic device of claim 1, wherein the narration information includes at least one of an indication of emotion and an indication of a mood that is generated by the at least one processor based on at least one of the content item and the first information item.

7. The electronic device of claim 1, wherein:
the at least one processor is further configured to identify an indication of a reaction of the user of the external device to the content item, and
the narration information is generated further based on the indication of the reaction.

8. The electronic device of claim 1, wherein:
the at least one processor is further configured to identify other narration information that is generated by the external device and is associated with the content item,
the narration information is generated further based on the other narration information.

9. The electronic device of claim 1, wherein:
the at least one processor is further configured to acquire a second information item associated with the electronic device or a user of the electronic device, compare the first information item and the second information item, and generate a first comparison information associated with both the first information item and the second information item, or a second comparison information associated with only one of the first information item or the second information item, and
the narration information is generated based on at least one of the first comparison information or the second comparison information.

10. A method comprising:
storing a content item in a memory of an electronic device;
acquiring, by the electronic device, a first information item corresponding to at least one of an external device or a user of the external device;
generating, by the electronic device, narration information corresponding to the content item based at least in part on the first information item; and
providing, by the electronic device, the content item and the narration information.

11. The method of claim 10, wherein the first information item comprises at least one of position information corresponding to the external device, address information, account information, or identification information.

12. The method of claim 10, wherein acquiring the first information item includes transmitting a request for the first information item to the external device.

13. The method of claim 10, further comprising detecting whether a first location indicated by the first information item is within a predetermined distance from a second location associated with the content item, wherein the narration information is generated based on whether the first location and the second location are within the predetermined distance from one another.

14. The method of claim 10, further comprising identifying at least one of a type of the external device and a use state of the external device based on the first information item, wherein the narration information is generated based on at least one of the type of the external device and the use state of the external device.

15. The method of claim 10, further comprising modifying the content item to include additional content, wherein the narration information is further generated based on the additional content.

16. The method of claim 10, wherein the content item is generated by at least one of the electronic device and the external device.

17. The method of claim 10, further comprising:
identifying at least one object that is represented by the content item;
identifying a location associated with the at least one object,
wherein the narration information is further generated based on the location associated with the at least one object.

18. The method of claim 10, further comprising:
identifying a first movement information associated with the electronic device and a second movement information associated with the external device; and
generating at least one of a first comparison information associated with both the first movement information and the second movement information, or a second comparison information associated with only one of the first movement information or the second movement information,
wherein the narration information comprises at least one of the first comparison information and the second comparison information.

19. The method of claim 10, wherein providing the narration information comprises transmitting a portion of the narration information to the external device and transmitting another portion of the narration information to another external device.

20. A non-transitory computer-readable medium storing one or more processor-executable instructions which when executed by at least one processor cause the at least one processor to perform a method comprising the steps of:
storing a content item in a memory of an electronic device;
acquiring a first information item corresponding to at least one of an external device or a user of the external device,
generating narration information corresponding to the content item based at least in part on the first information item, and
providing the content item and the narration information.
